(19) United States
(12) Patent Application Publication
(10) Pub. No.: US 2026/0212887 A1
(43) Pub. Date: Jul. 23, 2026

(54) MAGNETIC RECORDING MEDIUM AND CARTRIDGE

(71) Applicant: Sony Group Corporation, Tokyo (JP)

(72) Inventors: Taiki KAWAGUCHI, Tokyo (JP); Masaru TERAKAWA, Tokyo (JP); Takashi KATAGUCHI, Tokyo (JP); Miho MORIWAKI, Tokyo (JP)

(21) Appl. No.: 19/140,615

(22) PCT Filed: Jan. 25, 2024
(86) PCT No.: PCT/JP2024/002222

§ 371 Date: Jun. 18, 2025

(30) Foreign Application Priority Data
Jan. 31, 2023 (JP) 2023-013683

(51) Int. Cl. G11B 5/714; G11B 5/00; G11B 5/008; G11B 5/702; G11B 5/706

(52) U.S. Cl. CPC G11B 5/714; G11B 5/00813; G11B 5/7023; G11B 5/70615; G11B 2005/0029

(57) ABSTRACT

Provided is a magnetic recording medium capable of improving electromagnetic conversion characteristics even in a case where a particle volume of a magnetic powder is 1300 nm³ or less.

The magnetic recording medium is a tape-shaped magnetic recording medium, and includes a substrate and a magnetic layer containing a magnetic powder. A particle volume of the magnetic powder as determined by X-ray diffraction is 1300 nm³ or less. A ratio Hc/Hr of a coercive force Hc of the magnetic layer in a perpendicular direction of the magnetic recording medium and a residual coercive force Hr of the magnetic layer measured by applying a pulse magnetic field in the perpendicular direction of the magnetic recording medium is 0.45 or less.

### TECHNICAL FIELD

The present disclosure relates to a magnetic recording medium and a cartridge including the magnetic recording medium.

### BACKGROUND ART

In recent years, in a tape-shaped magnetic recording medium, miniaturization of a magnetic powder has been studied in order to improve electromagnetic conversion characteristics. Patent Document 1 describes that a favorable signal-to-noise ratio (SNR) is exhibited by including ferromagnetic hexagonal ferrite powder having a crystallite volume in a range of 1000 to 2400 nm³ in a magnetic layer.

### CITATION LIST

### Patent Document

Patent Document 1: Japanese Patent Application Laid-Open No. 2017-16721

### SUMMARY OF THE INVENTION

### Problems to be Solved by the Invention

However, in a case where the particle volume of the magnetic powder is small, electromagnetic conversion characteristics may be deteriorated. In a case where the particle volume of the magnetic powder is 1300 nm³ or less, the magnetic powder tends to include a large amount of magnetic nanoparticles, and deterioration of electromagnetic conversion characteristics tends to occur.

An object of the present disclosure is to provide a magnetic recording medium capable of improving electromagnetic conversion characteristics even in a case where a particle volume of a magnetic powder is 1300 nm³ or less, and a cartridge including the magnetic recording medium.

### Solutions to Problems

In order to solve the above problem, a magnetic recording medium according to the present disclosure is a magnetic recording medium having a tape shape, the magnetic recording medium including:
a substrate; and
a magnetic layer containing a magnetic powder,
in which a particle volume of the magnetic powder as determined by X-ray diffraction is 1300 nm³ or less, and
a ratio Hc/Hr of a coercive force Hc of the magnetic layer in a perpendicular direction of the magnetic recording medium and a residual coercive force Hr of the magnetic layer measured by applying a pulse magnetic field in the perpendicular direction of the magnetic recording medium is 0.45 or less.

A cartridge according to the present disclosure includes the above-described magnetic recording medium according to the present disclosure.

### BRIEF DESCRIPTION OF DRAWINGS

FIG. 1 is an exploded perspective view illustrating an example of a configuration of a cartridge according to an embodiment of the present disclosure.

FIG. 2 is a block diagram illustrating an example of a configuration of a cartridge memory.

FIG. 3 is a cross-sectional view illustrating an example of a configuration of a magnetic tape.

FIG. 4 is a schematic view illustrating an example of a layout of a data band and a servo band.

FIG. 5 is an enlarged view illustrating an example of a configuration of the data band.

FIG. 6 is an enlarged view illustrating an example of a configuration of the servo band.

FIG. 7 is a schematic view of an apparatus used for peeling a magnetic layer.

FIGS. 8A and 8B are graphs schematically showing a relationship between a particle size distribution of a magnetic powder and magnetic characteristics as measured by a VSM.

FIGS. 9A and 9B are graphs schematically showing a relationship between a particle size distribution of a magnetic powder and magnetic characteristics as measured by a pulse magnetic field VSM.

FIG. 10 is a graph for explaining a method of measuring a residual coercive force Hr of the magnetic layer.

FIG. 11 is an exploded perspective view illustrating an example of a configuration of a cartridge according to a modification of an embodiment of the present disclosure.

FIG. 12 is a graph showing a relationship between a particle volume of a magnetic powder and a ratio Hc/Hr.

### MODE FOR CARRYING OUT THE INVENTION

Embodiments of the present disclosure are described in the following order.
1 Background to present disclosure
2 Configuration of cartridge
3 Configuration of cartridge memory
4 Configuration of magnetic tape
5 Method for manufacturing magnetic powder
6 Method for manufacturing magnetic tape
7 Operation and effect
8 Modification
9 Examples

In the present specification, in a case where a measurement environment is not particularly described with respect to the description of a measurement method, the measurement is performed under an environment of 25° C.±2° C. and 50% RH±5% RH.

### 1 BACKGROUND TO PRESENT DISCLOSURE

The present inventors have conducted intensive studies on a magnetic recording medium capable of improving electromagnetic conversion characteristics even in a case where a particle volume of a magnetic powder is 1300 nm³ or less. Hereinafter, the contents of the studies will be described.

In order to improve the electromagnetic conversion characteristics of the magnetic recording medium, it is desirable to reduce the particle volume of the magnetic powder to improve packing of the magnetic powder. Furthermore, the particle size distribution of the magnetic powder may also contribute to improvement of electromagnetic conversion characteristics. In a case where the particle size distribution of the magnetic powder is wide, a large number of magnetic particles largely deviating from the average particle size are contained in the magnetic powder. Among the magnetic particles largely deviating from the average particle size, magnetic nanoparticles do not contribute to electromagnetic conversion characteristics, and tend to behave as a non-magnetic body. On the other hand, coarse magnetic particles among magnetic particles largely deviating from the average particle size may cause noise of a reproduction signal.

In view of the above points, in order to improve the electromagnetic conversion characteristics, it is necessary to make the particle size distribution of the magnetic powder sharp while reducing the particle volume of the magnetic powder. If the particle volume of the magnetic powder is reduced to 1300 nm³ or less, the proportion of the magnetic nanoparticles that can be non-magnetic tends to increase in the magnetic powder, and thus it is important to reduce the number of the magnetic nanoparticles.

As a method of measuring the particle size of the magnetic powder, a method of determining the particle size of the magnetic powder using an observation image by a scanning transmission electron microscope (STEM) is conventionally known. However, in a case where the particle volume of the magnetic powder is 1300 nm³ or less, in the method of measuring the particle size by an STEM, the measurement result of the particle size of the magnetic powder is likely to vary, and it is difficult to quantify the particle size of the magnetic powder. Thus, it is difficult to evaluate the sharpness of the particle size distribution of the magnetic powder using the measurement result of the particle size by STEM.

Therefore, the present inventors have intensively studied a technology capable of evaluating the sharpness of the particle size distribution of the magnetic powder even in a case where the particle volume of the magnetic powder is 1300 nm³ or less. As a result, they have found that the sharpness of the particle size distribution of the magnetic powder can be evaluated by a ratio Hc/Hr of a coercive force Hc of the magnetic layer in a perpendicular direction of the magnetic recording medium and a residual coercive force Hr of the magnetic layer measured by applying a pulse magnetic field in the perpendicular direction of the magnetic recording medium. The present disclosure has been found as a result of the studies described above.

### 2 CONFIGURATION OF CARTRIDGE

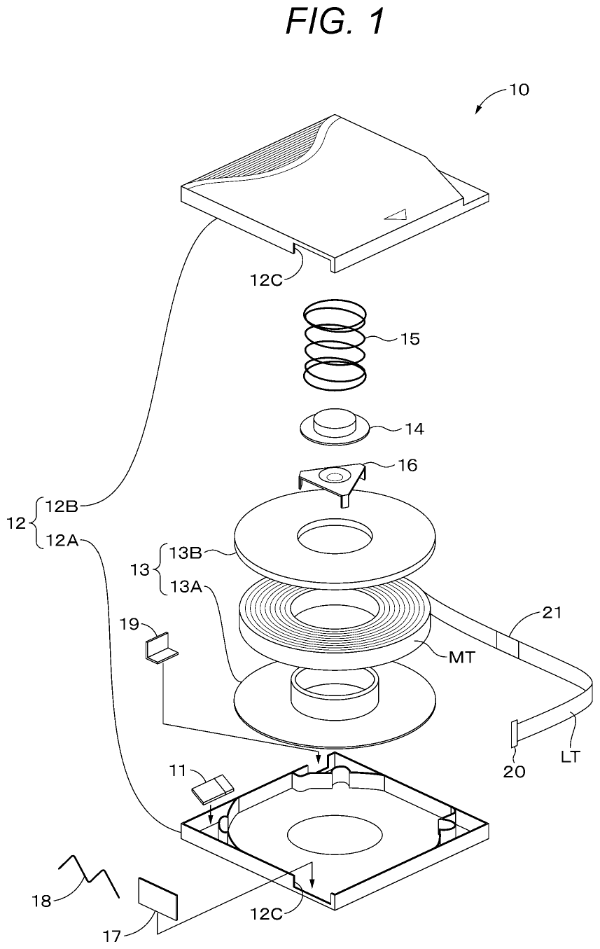

FIG. 1 is an exploded perspective view illustrating an example of a configuration of a cartridge 10 according to an embodiment. The cartridge 10 is a one-reel-type cartridge and includes, inside a cartridge case 12 including a lower shell 12A and an upper shell 12B, one reel 13 around which a tape-shaped magnetic recording medium (hereinafter, referred to as “magnetic tape”) MT is wound, a reel lock 14 and a reel spring 15 for locking rotation of the reel 13, a spider 16 for releasing a locked state of the reel 13, a slide door 17 that opens and closes a tape outlet port 12C provided at the cartridge case 12 across the lower shell 12A and the upper shell 12B, a door spring 18 that biases the slide door 17 toward a closed position of the tape outlet port 12C, a write protect 19 for preventing erroneous deletion, and a cartridge memory 11. The reel 13 for winding the magnetic tape MT has a substantially disk shape having an opening at its center, and is constituted by a reel hub 13A and a flange 13B made from a rigid material such as plastic. A leader tape LT is connected to an end portion of the magnetic tape MT on an outer circumferential side. A leader pin 20 is provided at a distal end of the leader tape LT.

The cartridge 10 may be a magnetic tape cartridge based on a linear tape-open (LTO) standard or may be a magnetic tape cartridge based on a standard different from the LTO standard.

The cartridge memory 11 is provided in the vicinity of one corner of the cartridge 10. In a state where the cartridge 10 is loaded in a recording/reproducing device, the cartridge memory 11 faces a reader/writer of the recording/reproducing device. The cartridge memory 11 communicates with a recording/reproducing device, specifically, a reader/writer based on a wireless communication standard according to the LTO standard.

### 3 CONFIGURATION OF CARTRIDGE MEMORY

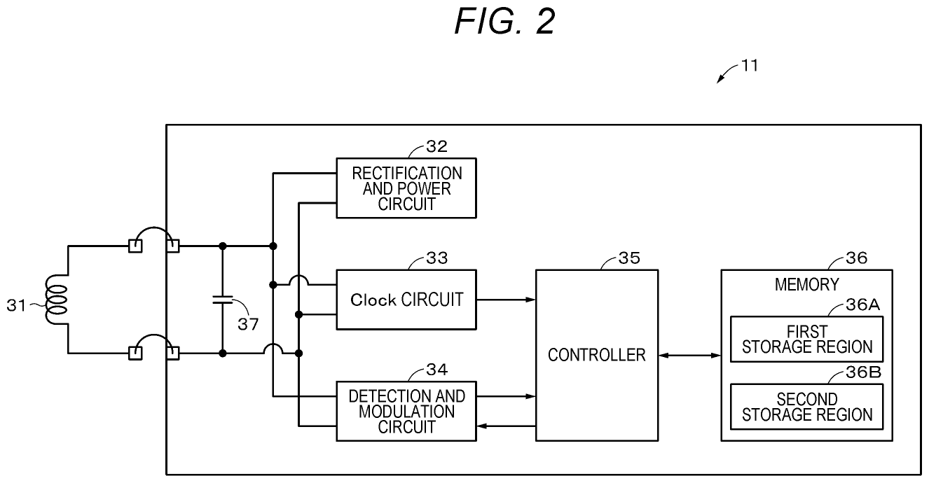

FIG. 2 is a block diagram illustrating an example of a configuration of the cartridge memory 11. The cartridge memory 11 includes an antenna coil (communication unit) 31 that communicates with a reader/writer according to a prescribed communication standard, a rectification and power circuit 32 that generates power by generating and rectifying power from radio waves received by the antenna coil 31 using an induced electromotive force, a clock circuit 33 that similarly generates a clock using an induced electromotive force from radio waves received by the antenna coil 31, a detection and modulation circuit 34 that detects radio waves received by the antenna coil 31 and modulates a signal to be transmitted by the antenna coil 31, a controller (control unit) 35 which is constituted by a logic circuit or the like for discriminating a command and data from a digital signal extracted from the detection and modulation circuit 34 and processing the command and data, and a memory (storage unit) 36 that stores information. Furthermore, the cartridge memory 11 includes a capacitor 37 which is connected to the antenna coil 31 in parallel, and a resonance circuit is constituted by the antenna coil 31 and the capacitor 37.

The memory 36 stores information and the like related to the cartridge 10. The memory 36 is a non volatile memory (NVM). A storage capacity of the memory 36 is preferably about 32 KB or more.

The memory 36 may have a first storage region 36A and a second storage region 36B. The first storage region 36A corresponds to, for example, a storage region of a cartridge memory of a magnetic tape standard before a specified generation (for example, LTO standards before LTO8), and is a region for storing information according to the magnetic tape standard before the specified generation. The information according to the magnetic tape standard before the specified generation is, for example, manufacturing information (for example, specific number of the cartridge 10 and the like), use history (for example, the number of times of tape draw-out (Thread Count)), and the like.

The second storage region 36B corresponds to an extension storage region for the storage region of the cartridge memory of the magnetic tape standard before the specified generation (for example, LTO standards before LTO8). The second storage region 36B is a region for storing additional information. Here, the additional information means, for example, information related to the cartridge 10 that is not prescribed in the magnetic tape standard before the specified generation (for example, LTO standards before LTO8). The additional information includes, for example, at least one type of information selected from the group consisting of tension adjustment information, management ledger data, index information, thumbnail information, and the like, but is not limited to these data. The tension adjustment information is information for adjusting the tension applied to the magnetic tape MT in a longitudinal direction. The tension adjustment information includes, for example, at least one type of information selected from the group consisting of information obtained by intermittently measuring a width between servo bands in the longitudinal direction of the magnetic tape MT, drive tension information, drive temperature and humidity information, and the like. These pieces of information may be managed in cooperation with information associated with a usage status of the cartridge 10, and the like. The tension adjustment information is preferably acquired at the time of data recording on the magnetic tape MT or before data recording. The drive tension information means information regarding the tension applied to the magnetic tape MT in the longitudinal direction.

The management ledger data is data including at least one selected from the group consisting of the capacity, creation date, editing date, storage location, and the like of a data file recorded on the magnetic tape MT. The index information is metadata or the like for searching the content of the data file. The thumbnail information is a thumbnail of a moving image or a still image stored on the magnetic tape MT.

The memory 36 may have a plurality of banks. In this case, some of the plurality of banks may constitute the first storage region 36A, and the remaining banks may constitute the second storage region 36B.

The antenna coil 31 induces an induced voltage by electromagnetic induction. The controller 35 communicates with the recording/reproducing device according to a prescribed communication standard through the antenna coil 31. Specifically, for example, mutual authentication, transmission and reception of commands, exchange of data, and the like are performed.

The controller 35 stores information received from the recording/reproducing device through the antenna coil 31 in the memory 36. For example, the tension adjustment information received from the recording/reproducing device through the antenna coil 31 is stored in the second storage region 36B of the memory 36. In response to a request from the recording/reproducing device, the controller 35 reads information from the memory 36, and transmits the information to the recording/reproducing device through the antenna coil 31. For example, in response to the request from the recording/reproducing device, the tension adjustment information is read from the second storage region 36B of the memory 36 and transmitted to the recording/reproducing device through the antenna coil 31.

### 4 CONFIGURATION OF MAGNETIC TAPE

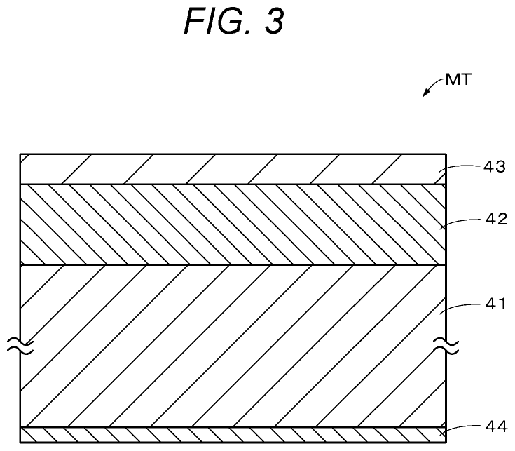

FIG. 3 is a cross-sectional view illustrating an example of a configuration of the magnetic tape MT. The magnetic tape MT includes an elongated substrate 41, a base layer 42 provided on one main surface (first main surface) of the substrate 41, a magnetic layer 43 provided on the base layer 42, and a back layer 44 provided on the other main surface (second main surface) of the substrate 41. Note that the base layer 42 and the back layer 44 are provided as necessary and are not necessarily provided. The magnetic tape MT may be a perpendicular recording type magnetic recording medium or may be a longitudinal recording type magnetic recording medium. The magnetic tape MT preferably contains a lubricant from the viewpoint of improving traveling performance. The lubricant may be contained in at least one layer of the base layer 42 and the magnetic layer 43.

The magnetic tape MT may conform to the LTO standard, or may conform to a standard different from the LTO standard. The width of the magnetic tape MT may be ½ inches, or may be wider than ½ inches. In a case where the magnetic tape MT conforms to the LTO standard, the width of the magnetic tape MT is ½ inches. The magnetic tape MT may have a configuration in which the width of the magnetic tape MT can be kept constant or substantially constant by adjusting tension, which is applied in the longitudinal direction of the magnetic tape MT during traveling, by the recording/reproducing device (drive).

The magnetic tape MT has an elongated shape and runs in the longitudinal direction during recording and reproducing. The magnetic tape MT is preferably used in a recording/reproducing device provided with a ring type head as a recording head. The magnetic tape MT is preferably used in a recording/reproducing device configured to be able to record data with a data track width of 1200 nm or less or 1000 nm or less.

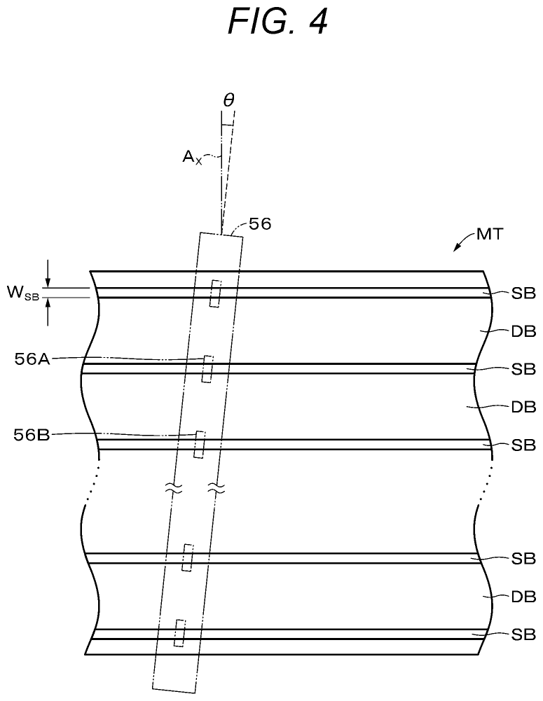

The magnetic tape MT is preferably reproduced by a reproducing head using a TMR element. A signal reproduced by the reproducing head using TMR may be data recorded in a data band DB (see FIG. 4) or may be a servo pattern (servo signal) recorded in the servo band SB (see FIG. 4).

### (Substrate)

The substrate 41 is a nonmagnetic supporting body which supports the base layer 42 and the magnetic layer 43. The substrate 41 has an elongated film shape. An upper limit value of the average thickness of the substrate 41 is preferably 4.40 μm or less, more preferably 4.20 μm or less, and still more preferably 4.00 μm or less, 3.80 μm or less, or 3.40 μm or less. In a case where the upper limit value of the average thickness of the substrate 41 is 4.40 μm or less, a recording capacity which can be recorded in one data cartridge may be increased as compared with that in a general magnetic tape. A lower limit value of the average thickness of the substrate 41 is preferably 3.00 un or more, and more preferably 3.20 μm or more. In a case where the lower limit value of the average thickness of the substrate 41 is 3.00 un or more, reduction in strength of the substrate 41 can be suppressed.

The average thickness of the substrate 41 is determined as follows. First, the magnetic tape MT accommodated in the cartridge 10 is unwound, and the magnetic tape MT is cut out to a length of 250 mm at a position of 30 m to 40 m in the longitudinal direction from one end of the magnetic tape MT on the outer circumferential side, thereby preparing a sample. In the present specification, the “longitudinal direction” in the case of the “longitudinal direction from one end of the magnetic tape MT on the outer circumferential side” means a direction from one end of the magnetic tape MT on the outer circumferential side toward the other end on the inner circumferential side.

Subsequently, layers other than the substrate 41 of the sample (that is, the base layer 42, the magnetic layer 43, and the back layer 44) are removed by a solvent such as methyl ethyl ketone (MEK) or dilute hydrochloric acid. Next, a thickness of the sample (substrate 41) is measured in five positions using a laser holo gauge (LGH-110C) manufactured by Mitutoyo Corporation as a measurement device, and the measured values are simply averaged (arithmetically averaged) to calculate the average thickness of the substrate 41. Note that the five measurement positions described above are randomly selected from the sample so as to be different positions in the longitudinal direction of the magnetic tape MT.

The substrate 41 contains, for example, a polyester-based resin as a main component. The polyester-based resin includes, for example, at least one selected from the group consisting of polyethylene terephthalate (PET), polyethylene naphthalate (PEN), polybutylene terephthalate (PBT), polybutylene naphthalate (PBN), polycyclohexylene dimethylene terephthalate (PCT), polyethylene-p(oxybenzoate) (PEB), and polyethylene bisphenoxycarboxylate. In a case where the substrate 41 contains two or more polyester-based resins, the two or more polyester-based resins may be mixed, copolymerized, or laminated. At least one of the terminal or the side chain of the polyester-based resin may be modified. The substrate 41 may contain a resin other than the polyester-based resin described later in addition to the polyester-based resin.

In the present specification, the “main component” means a component having the highest content ratio among the components constituting the substrate 41. For example, in a case where the main component of the substrate 41 is a polyester-based resin, the content ratio of the polyester-based resin in the substrate 41 may be, for example, 50 mass % or more, 60 mass % or more, 70 mass % or more, 80 mass % or more, 90 mass % or more, 95 mass % or more, or 98 mass % or more with respect to the mass of the substrate 41, or the substrate 41 may contain only the polyester-based resin.

The inclusion of the polyester-based resin in the substrate 41 is confirmed, for example, as follows. First, similarly to the method of measuring the average thickness of the substrate 41, the magnetic tape MT is prepared, and cut into a length of 250 mm to prepare a sample, and then layers other than the substrate 41 of the sample are removed. Next, an IR spectrum of the sample (substrate 41) is acquired by infrared absorption spectrometry (IR). It can be confirmed that the polyester-based resin is contained in the substrate 41 on the basis of the IR spectrum.

The substrate 41 preferably contains a polyester-based resin. In a case where the substrate 41 contains a polyester-based resin, the Young's modulus of the substrate 41 in the longitudinal direction can be reduced to preferably 2.5 GPa or more and 7.8 GPa or less, and more preferably 3.0 GPa or more and 7.0 GPa or less. Thus, the width of the magnetic tape MT can be kept constant or substantially constant by adjusting the tension in the longitudinal direction of the magnetic tape MT during traveling by the recording/reproducing device. A method of measuring the Young's modulus of the substrate 41 in the longitudinal direction will be described later.

The substrate 41 may contain a resin other than the polyester-based resin. In this case, the resin other than the polyester-based resin may be the main component of a constituent material of the substrate 41. In a case where the resin other than the polyester-based resin is the main component of the constituent material of the substrate 41, the content ratio of the resin other than the polyester-based resin in the substrate 41 may be, for example, 50 mass % or more, 60 mass % or more, 70 mass % or more, 80 mass % or more, 90 mass % or more, 95 mass % or more, or 98 mass % or more with respect to the mass of the substrate 41, or the substrate 41 may contain only the resin other than the polyester-based resin. The resin other than the polyester-based resin contains, for example, at least one selected from the group consisting of a polyolefin-based resin, a cellulose derivative, a vinyl-based resin, and other polymer resins. In a case where the substrate 41 contains two or more of these resins, the two or more materials may be mixed, copolymerized, or laminated.

The polyolefin-based resin includes, for example, at least one selected from the group consisting of polyethylene (PE) and polypropylene (PP). The cellulose derivative includes, for example, at least one selected from the group consisting of cellulose diacetate, cellulose triacetate, cellulose acetate butyrate (CAB), and cellulose acetate propionate (CAP). The vinyl-based resin includes, for example, at least one selected from the group consisting of polyvinyl chloride (PVC) and polyvinylidene chloride (PVDC).

The other polymer resins include, for example, at least one selected from the group consisting of polyether ether ketone (PEEK), polyamide (PA, nylon), aromatic polyamide (aromatic PA, aramid), polyimide (PI), aromatic polyimide (aromatic PI), polyamide imide (PAI), aromatic polyamide imide (aromatic PAI), polybenzoxazole (PBO, for example, ZYLON (registered trademark)), polyether, polyether ketone (PEK), polyether ester, polyether sulfone (PES), polyether imide (PEI), polysulfone (PSF), polyphenylene sulfide (PPS), polycarbonate (PC), polyarylate (PAR), and polyurethane (PU). Specifically, for example, the substrate 41 may contain, as a main component, polyether ether ketone (PEEK), polyamide (PA, nylon), aromatic polyamide (aromatic PA, aramid), polyimide (PI), aromatic polyimide (aromatic PI), polyamide imide (PAI), aromatic polyamide imide (aromatic PAI), polybenzoxazole (PBO, for example, ZYLON (registered trademark)), polyether, polyether ketone (PEK), polyether ester, polyether sulfone (PES), polyether imide (PEI), polysulfone (PSF), polyphenylene sulfide (PPS), polycarbonate (PC), polyarylate (PAR), or polyurethane (PU).

The substrate 41 may be biaxially stretched in the longitudinal direction and the width direction. The polymer resin contained in the substrate 41 is preferably oriented in an oblique direction with respect to the width direction of the substrate 41.

### (Magnetic Layer)

The magnetic layer 43 is configured to be able to record a signal by a magnetization pattern. The magnetic layer 43 may be a perpendicular recording type recording layer or may be a longitudinal recording type recording layer. The magnetic layer 43 contains, for example, a magnetic powder and a binder. The magnetic layer 43 may further contain, as necessary, at least one additive selected from the group consisting of conductive particles, a lubricant, abrasive particles, a curing agent, a rust inhibitor, and non-magnetic reinforcing particles, and the like. The magnetic layer 43 may have a plurality of protrusions on a surface (magnetic surface) on the magnetic layer 43 side. The plurality of protrusions is formed by, for example, conductive particles and abrasive particles protruding from the magnetic surface.

As illustrated in FIG. 4, the magnetic layer 43 may have a plurality of servo bands SB and a plurality of data bands DB in advance. The plurality of servo bands SB is provided at equal intervals in a width direction of the magnetic tape MT. The data band DB is provided between the adjacent servo bands SB. The servo band SB is for guiding a head unit (magnetic head) 56 (specifically, servo read heads 56A and 56B) at the time of recording or reproducing data. In the servo band SB, a servo pattern (servo signal) for performing tracking control on the head unit 56 is written in advance. User data is recorded in the data band DB.

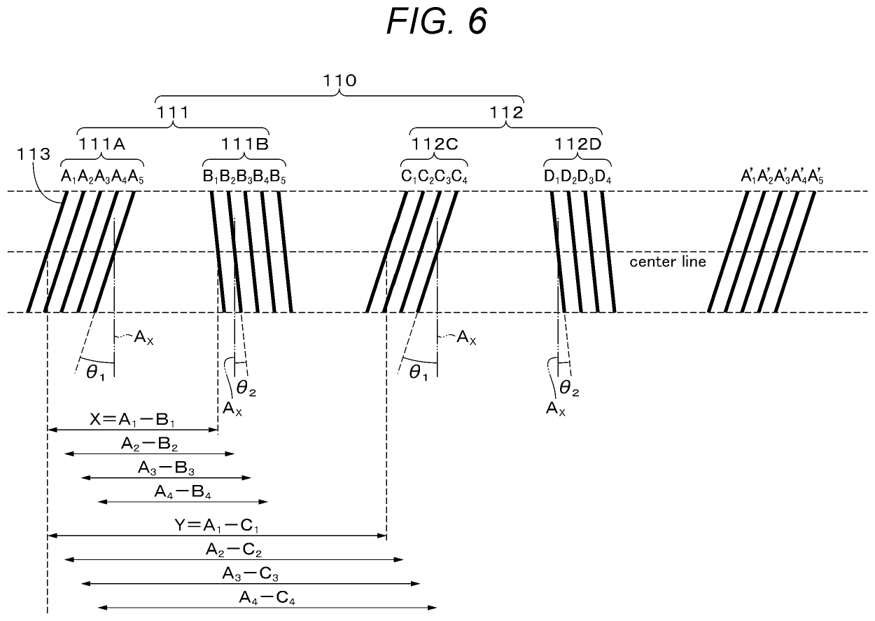

In order to read asymmetric servo stripes 113 described later (see FIG. 6), as illustrated in FIG. 4, the head unit 56 may be configured to be able to be maintained obliquely with respect to an axis Ax parallel to the width direction of the magnetic tape MT at the time of recording or reproducing data. Alternatively, the head unit 56 may be configured to be inclined with respect to the axis Ax following the meandering or deformation of the magnetic tape MT at the time of recording or reproducing data. The inclination angle of the head unit 56 based on the axis Ax parallel to the width direction of the magnetic tape MT is preferably 3° or more and 18° or less, and more preferably 5° or more and 15° or less.

An upper limit value of a ratio Rₛ(=(S_{SB}/S)×100) of a total area S_{SB} of the plurality of servo bands SB to an area S of the magnetic surface (surface on the magnetic layer 43 side) is preferably 4.0% or less, more preferably 3.5% or less, and still more preferably 3.0% or less from the viewpoint of securing a high recording capacity. On the other hand, a lower limit value of the ratio Rₛ of the total area S_{SB} of the plurality of servo bands SB to the area S of the magnetic surface is preferably 1.0% or more from the viewpoint of securing five or more servo bands SB.

The ratio Rₛ of the total area S_{SB} of the plurality of servo bands SB to the area S of the entire magnetic surface is determined as follows. The magnetic tape MT is developed using a ferri-colloid developer (Sigmarker Q manufactured by Sigma Hi-Chemical), and then, the developed magnetic tape MT is observed with an optical microscope to measure a servo band width W_{SB} and the number of the servo bands SB. Next, the ratio Rₛ is determined from the following equation.

Ratio Rₛ [%]=(((servo band width W_{SB})×(number of servo bands SB))/(width of magnetic tape MT))×100

The number of servo bands SB is, for example, 5+4n (where n is an integer of 0 or more) or more. The number of servo bands SB is preferably 5 or more, and more preferably 9 or more. In a case where the number of servo bands SB is 5 or more, the influence of a dimensional change in the width direction of the magnetic tape MT on the servo signal is suppressed, and a stable recording/reproducing characteristic with smaller off-track can be secured. An upper limit value of the number of servo bands SB is not particularly limited, but is, for example, 33 or less.

The number of servo bands SB is determined in a similar manner to the method of calculating the ratio Rₛ described above.

An upper limit value of the servo band width W_{SB} is preferably 95 μm or less, more preferably 65 μm or less, and still more preferably 50 μm or less from the viewpoint of securing a high recording capacity. A lower limit value of the servo band width W_{SB} is preferably 10 μm or more. It is difficult to manufacture a magnetic head capable of reading a servo signal having a servo band width W_{SB} of less than 10 μm.

The width of the servo band width W_{SB} is determined in a similar manner to the method of calculating the ratio Rₛ described above.

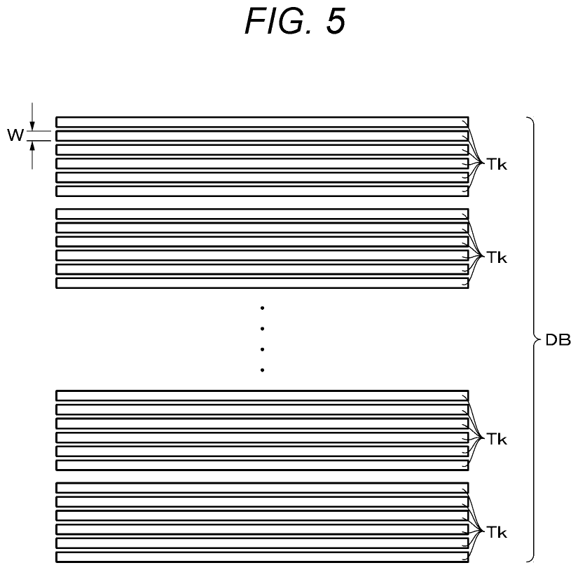

As illustrated in FIG. 5, the magnetic layer 43 is configured to be able to form a plurality of data tracks Tk in the data band DB. An upper limit value of a data track width W is preferably 1200 nm or less, more preferably 1000 nm or less, and still more preferably 850 nm or less, 800 nm or less, or 600 nm or less from the viewpoint of improving a track recording density and securing a high recording capacity. A lower limit value of the data track width W is preferably 20 nm or more in consideration of a magnetic particle size.

The data track width W is determined as follows. First, the cartridge 10 in which data is recorded on the entire surface of the magnetic tape MT is prepared, the magnetic tape MT is unwound from the cartridge 10, and the magnetic tape MT is cut out to a length of 250 mm at a position of 30 m to 40 m in the longitudinal direction from one end of the magnetic tape MT on the outer circumferential side, thereby preparing a sample. Subsequently, a data recording pattern of a data band DB portion of the magnetic layer 43 of the sample is observed using a magnetic force microscope (MFM) to obtain an MFM image. As the MFM, Dimension 3100 manufactured by Digital Instruments, Inc. and its analysis software are used. A measurement region for the MFM image is 10 μm×10 μm, and the measurement region of 10 μm×10 μm is divided into 512×512 (=262,144) measurement points. Measurement by MFM is conducted for three 10 μm×10 μm measurement regions at different locations, and thus, three MFM images are obtained. From the three MFM images thus obtained, the track width is measured at 10 locations, the measured values at 30 points in total are acquired, and the average value (simple average) of the measured values at 30 points is calculated. The average value is the data track width W. For the measurement of the track width, analysis software attached to Dimension 3100 is used. Note that measurement conditions for the MFM described above are scanning speed: 1 Hz, chip used: MFMR-20, lift height: 20 nm, and correction: Flatten order 3.

The magnetic layer 43 is configured to be able to record data so that a minimum value Lₘᵢₙ of a distance between magnetization reversals is preferably 47 nm or less, more preferably 44 nm or less, still more preferably 42 nm or less, and particularly preferably 40 nm or less from the viewpoint of securing a high recording capacity. A lower limit value of the minimum value Lₘᵢₙ of the distance between magnetization reversals is preferably 20 nm or more in consideration of a magnetic particle size.

The minimum value Lₘᵢₙ of the distance between magnetization reversals is determined as follows. First, a sample is prepared in a similar manner to the method of measuring the data track width W. Subsequently, a data recording pattern of a data band DB portion of the magnetic layer 43 of the sample is observed using a magnetic force microscope (MFM) to obtain an MFM image. As the MFM, Dimension 3100 manufactured by Digital Instruments, Inc. and its analysis software are used. A measurement region for the MFM image is 2 μm×2 μm, and the measurement region of 2 μm×2 μm is divided into 512×512 (=262,144) measurement points. Measurement by MFM is conducted for three 2 μm×2 μm measurement regions at different locations, and thus, three MFM images are obtained. From two-dimensional rugged charts of record patterns of the MFM images thus obtained, a distance between bits is measured at 50 locations. The measurement of the distance between bits is conducted using analysis software attached to Dimension 3100. A value approximately equal to the greatest common divisor of the measured 50 distances between bits is taken as the minimum value Lₘᵢₙ of the distance between magnetization reversals. Note that measurement conditions are scanning speed: 1 Hz, chip used: MFMR-20, lift height: 20 nm, and correction: Flatten order 3.

A bit length L_{bit} of a signal to be recorded in the data band DB is preferably 47 nm or less or 46 nm or less, more preferably 44 nm or less, still more preferably 42 nm or less, and particularly preferably 40 nm or less from the viewpoint of improving a recording density of the magnetic tape MT.

The bit length L_{bit} of a signal to be recorded in the data band DB is determined in a similar manner to the method of measuring the minimum value Lₘᵢₙ of the distance between magnetization reversals.

A bit area of a signal to be recorded in the data band DB is preferably 53000 nm² or less, more preferably 45000 nm² or less, still more preferably 37000 nm² or less, and particularly preferably 30000 nm² or less from the viewpoint of improving a recording density of the magnetic tape MT.

The bit area of the signal to be recorded in the data band DB is determined as follows. First, three MFM images are obtained in a similar manner to the method of measuring the data track width W. Next, the data track width W and the bit length L_{bit} are determined in a similar manner to the method of measuring the data track width W and the method of measuring the bit length L_{bit}. Next, the bit area (W×L_{bit}) of the signal to be recorded in the data band DB is determined using the data track width W and the bit length L_{bit}.

The servo pattern is a magnetized region, and is formed by magnetizing a specific region of the magnetic layer 43 in a specific direction with a servo write head during manufacturing of the magnetic tape. Of the servo band SB, a region in which no servo pattern is formed (hereinafter, referred to as “non-pattern region”) may be a magnetized region in which the magnetic layer 43 has been magnetized or a non-magnetized region in which the magnetic layer 43 is not magnetized. In a case where non-pattern region is a magnetized region, a servo pattern forming region and a non-pattern region have been magnetized in different directions (for example, opposite directions).

In the LTO standard, as illustrated in FIG. 6, servo patterns including a plurality of servo stripes (linear magnetized regions) 113 inclined with respect to the axis Ax parallel to the width direction of the magnetic tape MT are formed in the servo band SB.

The servo band SB includes a plurality of servo frames 110. Each of the servo frames 110 includes 18 servo stripes 113. Specifically, each of the servo frames 110 includes a servo sub-frame 1 (111) and a servo sub-frame 2 (112).

The servo sub-frame 1 (111) includes an A burst 111A and a B burst 111B. The B burst 111B is disposed adjacent to the A burst 111A. The A burst 111A includes five servo stripes 113 that are inclined with respect to the axis Ax parallel to the width direction of the magnetic tape MT at a predetermined angle θ₁ and formed apart by specified intervals. In FIG. 6, these five servo stripes 113 are denoted by reference symbols A₁, A₂, A₃, A₄, and Aₛ from the end of tape (EOT) to the beginning of tape (BOT) of the magnetic tape MT.

The B burst 111B includes five servo stripes 113 that are inclined with respect to the axis Ax parallel to the width direction of the magnetic tape MT at a predetermined angle θ₂ and formed apart by specified intervals. In FIG. 6, these five servo stripes 113 are denoted by reference symbols B₁, B₂, B₃, B₄, and B₅ from the EOT to the BOT of the magnetic tape MT.

The servo stripes 113 of the B burst 111B are inclined in the opposite direction to the servo stripes 113 of the A burst 111A. The servo stripes 113 of the A burst 111A and the servo stripes 113 of the B burst 111B have asymmetry with respect to the axis Ax parallel to the width direction of the magnetic tape MT. That is, the servo stripes 113 of the A burst 111A and the servo stripes 113 of the B burst 111B are arranged in a substantially inverted V-shape. Since the servo stripes 113 of the A burst 111A and the servo stripes 113 of the B burst 111B have asymmetry with respect to the axis Ax, when the head unit 56 is inclined obliquely with respect to the axis Ax, there is a state where the servo stripes 113 of the A burst 111A and the servo stripes 113 of the B burst 111B are substantially symmetrical with respect to the central axis of the sliding surface of the head unit 56. By changing the inclination of the head unit 56 with reference to this state, a distance between the servo read heads 56A and 56B in the width direction of the magnetic tape MT can be adjusted. Thus, in a case where the width of the magnetic tape MT is increased and a case where the width of the magnetic tape MT is decreased, the servo read heads 56A and 56B can be opposed to the specified positions of the servo band SB. Note that the central axis of the sliding surface of the head unit 56 means an axis passing through the centers of the plurality of servo read heads 56A and 56B on the sliding surface of the head unit 56.

The predetermined angle θ₁ that is the inclination angle of the servo stripes 113 of the A burst 111A is different from the predetermined angle θ₂ that is the inclination angle of the servo stripes 113 of the B burst 111B. More specifically, the predetermined angle θ₁ of the servo stripes 113 of the A burst 111A may be larger than the predetermined angle θ₂ of the servo stripes 113 of the B burst 111B, or the predetermined angle θ₂ of the servo stripes 113 of the B burst 111B may be larger than the predetermined angle θ₁ of the servo stripes 113 of the A burst 111A. That is, the inclination of the servo stripes 113 of the A burst 111A may be larger than the inclination of the servo stripes 113 of the B burst 111B, or the inclination of the servo stripes 113 of the B burst 111B may be larger than the inclination of the servo stripes 113 of the A burst 111A. Note that FIG. 6 illustrates an example in which the predetermined angle θ₁ of the servo stripes 113 of the A burst 111A is larger than the predetermined angle θ₂ of the servo stripes 113 of the B burst 111B. Hereinafter, a case where the predetermined angle θ₁ of the servo stripes 113 of the A burst 111A is larger than the predetermined angle θ₂ of the servo stripes 113 of the B burst 111B will be described.

The servo sub-frame 2 (112) includes a C burst 112C and a D burst 112D. The D burst 112D is disposed adjacent to the C burst 112C. The C burst 112C includes four servo stripes 113 that are inclined with respect to the axis Ax parallel to the width direction of the magnetic tape MT at a predetermined angle θ₁ and formed apart by specified intervals. In FIG. 6, these four servo stripes 113 are denoted by reference symbols C₁, C₂, C₃, and C₄ from the EOT to the BOT of the magnetic tape MT.

The D burst 112D includes four servo stripes 113 that are inclined with respect to the axis Ax parallel to the width direction of the magnetic tape MT at a predetermined angle θ₂ and formed apart by specified intervals. In FIG. 6, these four servo stripes 113 are denoted by reference symbols D₁, D₂, D₃, and D₄ from the EOT to the BOT of the magnetic tape MT.

The servo stripes 113 of the D burst 112D are inclined in the opposite direction to the servo stripes 113 of the C burst 112C. The servo stripes 113 of the C burst 112C and the servo stripes 113 of the D burst 112D have asymmetry with respect to the axis Ax parallel to the width direction of the magnetic tape MT. That is, the servo stripes 113 of the C burst 112C and the servo stripes 113 of the D burst 112D are arranged in a substantially inverted V-shape. Since the servo stripes 113 of the C burst 112C and the servo stripes 113 of the D burst 112D have asymmetry with respect to the axis Ax, when the head unit 56 is inclined obliquely with respect to the axis Ax, there is a state where the servo stripes 113 of the C burst 112C and the servo stripes 113 of the D burst 112D are substantially symmetrical with respect to the central axis of the head unit 56. By changing the inclination of the head unit 56 with reference to this state, a distance between servos can be adjusted.

The predetermined angle θ₁ that is the inclination angle of the servo stripes 113 of the C burst 112C is different from the predetermined angle θ₂ that is the inclination angle of the servo stripes 113 of the D burst 112D. More specifically, the predetermined angle θ₁ of the servo stripes 113 of the C burst 112C may be larger than the predetermined angle θ₂ of the servo stripes 113 of the D burst 112D, or the predetermined angle θ₂ of the servo stripes 113 of the D burst 112D may be larger than the predetermined angle θ₁ of the servo stripes 113 of the C burst 112C. That is, the inclination of the servo stripes 113 of the C burst 112C may be larger than the inclination of the servo stripes 113 of the D burst 112D, or the inclination of the servo stripes 113 of the D burst 112D may be larger than the inclination of the servo stripes 113 of the C burst 112C. Note that FIG. 6 illustrates an example in which the predetermined angle θ₁ of the servo stripes 113 of the C burst 112C is larger than the predetermined angle θ₂ of the servo stripes 113 of the D burst 112D. Hereinafter, a case where the predetermined angle θ₁ of the servo stripes 113 of the C burst 112C is larger than the predetermined angle θ₂ of the servo stripes 113 of the D burst 112D will be described.

The predetermined angle θ₁ of the servo stripes 113 in the A burst 111A and the C burst 112C is preferably 18° or more and 28° or less, and more preferably 18° or more and 26° or less. The predetermined angle θ₂ of the servo stripes 113 in the B burst 111B and the D burst 112D is preferably −4° or more and 6° or less, and more preferably −2° or more and 6° or less. The servo stripes 113 in the A burst 111A and the C burst 112C are an example of the first magnetized region. The servo stripes 113 in the B burst 111B and the D burst 112D are an example of the second magnetized region.

By reading the servo band SB with the head unit 56, information for acquiring the tape speed and the position of the head unit 56 in the vertical direction can be obtained. The tape speed is calculated from the time between four timing signals (A1-C1, A2-C2, A3-C3, and A4-C4). The head position is calculated from the time between the above-mentioned four timing signals and the time between other four timing signals (A1-B1, A2-B2, A3-B3, and A4-B4). The servo pattern may have a shape including two parallel lines.

As illustrated in FIG. 6, it is preferable that the servo patterns (that is, the plurality of servo stripes 113) are linearly arranged toward the longitudinal direction of the magnetic tape MT. That is, the servo band SB preferably has a straight line shape in the longitudinal direction of the magnetic tape MT.

An upper limit value of an average thickness t₁ of the magnetic layer 43 is preferably 80 nm or less, more preferably 70 nm or less, still more preferably 60 nm or less, and particularly preferably 50 nm or less. If the upper limit value of the average thickness tᵢ of the magnetic layer 43 is 80 nm or less, the influence of the demagnetizing field can be reduced in a case where a ring type head is used as a recording head, so that more excellent electromagnetic conversion characteristics can be obtained.

A lower limit value of the average thickness tᵢ of the magnetic layer 43 is preferably 35 nm or more. If the lower limit value of the average thickness tᵢ of the magnetic layer 43 is 35 nm or more, output can be secured in a case where an MR type head is used as the reproducing head, so that more excellent electromagnetic conversion characteristics can be obtained.

The average thickness tᵢ of the magnetic layer 43 is determined as follows. First, the magnetic tape MT accommodated in the cartridge 10 is unwound, and the magnetic tape MT is cut out to a length of 250 mm at each of a position of 10 m to 20 m, a position of 30 m to 40 m, and a position of 50 m to 60 m in the longitudinal direction from one end of the magnetic tape MT on the outer circumferential side, thereby preparing three samples. Subsequently, each sample is processed to make a slice by an FIB method or the like. In the case of using an FIB method, as pretreatment for observing a TEM image of a cross section described below, a carbon layer and a tungsten layer are formed as protective films. The carbon layer is formed on the surfaces of the magnetic tape MT on the magnetic layer 43 side and on the back layer 44 side by a deposition method, and then, the tungsten layer is further formed on the surface on the magnetic layer 43 side by a deposition method or sputtering method. The slicing is performed along the longitudinal direction of the magnetic tape MT. That is, the slicing forms a cross section parallel to both the longitudinal direction and the thickness direction of the magnetic tape MT.

The above-described cross section of each sliced sample thus obtained is observed with a transmission electron microscope (TEM) under the following conditions to obtain a TEM image of each sliced sample. Note that the magnification and acceleration voltage may be appropriately adjusted depending on the type of the apparatus.
Device: TEM (H9000NAR manufactured by Hitachi. Ltd.)
Acceleration voltage: 300 kV
Magnification: 100,000 times

Next, the TEM image of each sliced sample thus obtained is used, and the thickness of the magnetic layer 43 is measured at 10 points of each sliced sample. Note that 10 measurement positions of each sliced sample are randomly selected from the sample so as to be different positions in the longitudinal direction of the magnetic tape MT. The average value obtained by simply averaging (arithmetically averaging) the measured values (thicknesses of the magnetic layer 43 at 30 points in total) of each sliced sample thus obtained is taken as the average thickness tᵢ[nm] of the magnetic layer 43.

### (Magnetic Powder)

The magnetic powder contains, for example, hexagonal ferrite particles as magnetic particles. The magnetic powder preferably has crystal orientation preferentially in the perpendicular direction of the magnetic tape MT. In the present specification, the perpendicular direction (thickness direction) of the magnetic tape MT represents the thickness direction of the magnetic tape MT.

The hexagonal ferrite particles each have, for example, a plate shape such as a hexagon plate shape or a columnar shape such as hexagonal columnar shape (provided that the thickness or height is smaller than the major axis of the plate surface or the bottom surface). In the present specification, the hexagonal plate shape includes a substantially hexagonal plate shape. Furthermore, the hexagonal columnar shape includes a substantially hexagonal columnar shape.

The hexagonal ferrite particles contain Fe and a metal M1 other than Fe. The metal M1 contains an alkaline earth metal. The alkaline earth metal contains at least Ba. The alkaline earth metal may further contain at least one of Sr or Ca other than Ba, and preferably contains Sr among these metals. The metal M1 may contain Pb in addition to the alkaline earth metal.

The hexagonal ferrite particles may further contain a metal M2 other than Fe and the metal M1. The metal M2 can substitute a site of Fe in the crystal structure of the hexagonal ferrite. The metal M2 contains, for example, at least one selected from the group consisting of a rare earth element, a transition metal element other than Fe, and a metal element of Group 13 of the periodic table, and among these, at least one selected from the group consisting of Ti, Al, and Nd is preferable.

In the present disclosure, the rare earth element refers to Y, La, Ce, Pr, Nd, Pm, Sm, Eu, Gd, Tb, Dy, Ho, Er, Tm, Yb, and Lu. The transition metal element other than Fe refers to Ti, V, Cr, Mn, Co, Ni, Cu, Zn, Zr, Nb, Mo, Ru, Hf, Ta, and W. The metal element of Group 13 of the periodic table refers to Al, Ga, In, and Tl.

Specifically, the hexagonal ferrite particles may be, for example, barium ferrite particles or strontium ferrite particles. In the present disclosure, the strontium ferrite particles refer to hexagonal ferrite particles having an atomic ratio of Sr to the metal M1 of 50 atom % or more. Thus, the hexagonal ferrite particles containing Sr and the metal M1 other than Sr are included in the strontium ferrite particles in a case where the atomic ratio of Sr to the metal M1 is 50 atom % or more. For example, in a case where the metal M1 contains Sr and Ba, hexagonal ferrite particles in which an atomic ratio of Sr to the total amount of Sr and Ba is 50 atom % or more are referred to as strontium ferrite particles.

In the present disclosure, the barium ferrite particles refer to hexagonal ferrite particles having an atomic ratio of Ba to the metal M1 of 50 atom % or more. Thus, the hexagonal ferrite particles containing Ba and the metal M1 other than Ba are included in the barium ferrite particles in a case where the atomic ratio of Ba to the metal M1 is 50 atom % or more. For example, in a case where the metal M1 contains Sr and Ba, hexagonal ferrite particles in which an atomic ratio of Ba to the total amount of Sr and Ba is 50 atom % or more are referred to as barium ferrite particles.

More specifically, the hexagonal ferrite may have an average composition represented by the following General Formula (1).

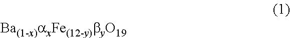

where in Formula (1), a represents at least one selected from the group consisting of Sr, Ca, and Pb, β is at least one selected from the group consisting of a rare earth element, a transition metal element other than Fe, and a metal element of Group 13 of the periodic table, x is within a range of 0 5×5 0.9, preferably 0≤x≤0.7, and still more preferably 0.3 5×5 0.7, and y represents 0≤y≤0.80, preferably 0.22≤y≤0.80, and more preferably 0.26≤y≤0.80.
   (Particle volume V_{XRD} of magnetic powder)

An upper limit value of the particle volume V_{XRD} of the magnetic powder is 1300 nm³ or less, preferably 1200 nm³ or less, and more preferably 1139 nm³ or less, 1068 nm³ or less, or 942 nm³ or less. In a case where the particle volume V_{XRD} of the magnetic powder exceeds 1300 nm³, the number of magnetic particles included in a unit area decreases, and thus electromagnetic conversion characteristics deteriorate. In the present specification, the particle volume V_{XRD} of the magnetic powder represents the crystallite volume of the magnetic powder obtained by taking out the constituent material of the magnetic layer 43 of the magnetic tape MT and measuring the constituent material by XRD.

A lower limit value of the particle volume V_{XRD} of the magnetic powder determined by X-ray diffraction is preferably 800 nm³ or more, and more preferably 900 nm³ or more. In a case where the particle volume V_{XRD} of the magnetic powder is 800 nm³ or more, deterioration of a reproduction signal due to thermal fluctuation can be suppressed. Thus, electromagnetic conversion characteristics can be improved.

The numerical range of the particle volume V_{XRD} of the magnetic particles may be defined by any of the above-described upper limit values and any of the above-described lower limit values, and may be preferably 800 nm³ or more and 1300 nm³ or less, more preferably 800 nm³ or more and 1200 nm³ or less, and still more preferably 800 nm³ or more and 1139 nm³ or less, 800 nm³ or more and 1068 nm³ or less, or 800 nm³ or more and 942 nm³ or less.

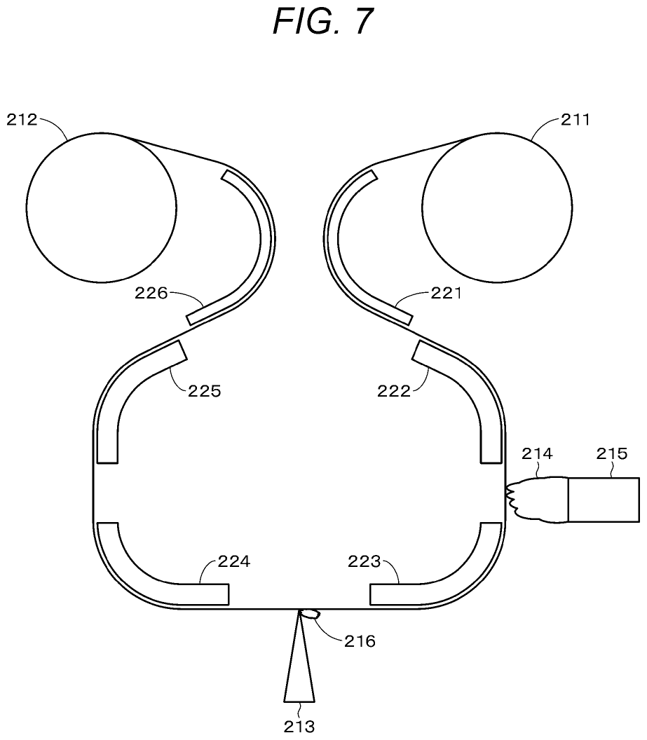

A crystallite volume V_{XRD} of the magnetic powder is determined as follows. First, a reel 211 around which the magnetic tape MT has been wound is attached to a traveling system (for example, MTS Transport 2′×3′ deck manufactured by Mountain engineering II, Inc.) illustrated in FIG. 7. A support member 215 that supports a nonwoven fabric 214 and a blade 213 are provided in the traveling system. The support member 215 is provided on the upstream side of a traveling path with respect to the blade 213. The nonwoven fabric 214 is impregnated with a solvent such as ethanol, methyl ethyl ketone, or acetone.

Next, one end of the magnetic tape MT on the outer circumferential side is unwound from the reel 211, the magnetic tape MT is set on a predetermined traveling path on which tape traveling guides 221, 222, 223, 224, 225, and 226 are provided, and one end of the magnetic tape MT is fixed to a reel 212.

Next, the traveling system is driven, and the blade 213 and the nonwoven fabric 214 are slid on the surface of the magnetic layer 43. Therefore, after the surface of the magnetic layer 43 is wetted by the nonwoven fabric 214, the surface of the magnetic layer 43 is thinly peeled off by the blade 213, and a peeled product (constituent material of the magnetic layer 43) 216 of the magnetic layer 43 is acquired. Acquisition of the peeled product 216 is performed until the amount of the peeled product 216 reaches an amount required for XRD measurement described later. In a case where a required amount of the peeled product 216 is not acquired from the magnetic tape MT of one reel 211, a required amount of the peeled product 216 is acquired from the magnetic tapes MT of two or more reels 211. For example, in a case where the cartridge 10 is a cartridge conforming to the LTO9 standard, the magnetic layer 43 is peeled off over a length of about 1000 m from the magnetic tape MT of the one-turn cartridge 10, thereby acquiring a required amount of the peeled product 216.

Next, the peeled product 216 is placed in the recess (square, 1.8 cm×2.0 cm) of a non-reflective silicon sample plate for XRD, and leveled with a glass plate to prepare a measurement sample. Subsequently, the X-ray diffraction pattern of the measurement sample is measured by a concentration method.

For hexagonal ferrite represented by the composition formula: BaFe₁₂O₁₉, a crystallite size D₁ obtained from the diffraction peak of the (0,0,6) plane is calculated, and for hexagonal ferrite containing Sr, the crystallite size D₁ is calculated by multiplying the crystallite size obtained from the diffraction peak of the (1,1,4) plane by a correction coefficient of 0.5406. Here, the crystallite size D₁ is a value corresponding to the plate thickness of the particle.

Note that, in the hexagonal ferrite containing Sr, the intensity of the (0,0,6) plane is weak, and thus the crystallite size D₁ is calculated by applying a correction coefficient to the (1,1,4) plane having a relatively high intensity. Furthermore, a crystallite size D₂ is calculated from the diffraction peak of the (2,2,0) plane. Here, the crystallite size D₂ is a value corresponding to the plate diameter of the particle. For the calculation of the crystallite size D₁ and the crystallite size D₂, the following Scherrer's formula is used.

Scherrer's formula: Dx=Kλ/B cos θ
Dx: crystallite size (nm)
λ: measured X-ray wavelength (nm)
B: spreading of diffraction line due to crystallite size (half-value width of diffraction peak)
θ: angle at which diffraction peak appears
K: Scherrer constant (=0.94)

The measurement conditions of the X-ray diffraction are as follows.
Equipment used: XRD (Ultima IV manufactured by Rigaku Corporation)
Measurement mode: concentration method
Radiation source: Co (CoKα ray, wavelength λ=0.179 nm)
Voltage: 40 kV
Current: 40 mA
Divergence slit: ½°
Divergence vertical restriction slit: 5 mm
Scattering slit: 8 mm
Light receiving slit: open
Step width: 0.02°
Scan speed: 1°/min
Scanning range: 20° to 80°
Analysis software: PDXL2

Next, the crystallite volume V_{XRD} of the magnetic powder is determined by the following formula.

$$[ Math . 1 ]$$

$${V}_{XRD} = \frac{3 \sqrt{3}}{8} \times {D}_{1} \times {D}_{2} \times {D}_{2}$$

where D₁ is a crystallite size calculated from the diffraction peak of the (0,0,6) plane in the case of hexagonal ferrite represented by the composition formula: BaFe₁₂C₁₉, and a value obtained by multiplying the crystallite size obtained from the diffraction peak of the (1,1,4) plane by a correction coefficient of 0.5406 in the case of hexagonal ferrite containing Sr. D₂ is a crystallite size calculated from the diffraction peak of the (2,2,0) plane.

### (Binder)

The binder contains, for example, a thermoplastic resin. The binder may further contain a thermosetting resin, a reactive resin, or the like.

The thermoplastic resin includes a first thermoplastic resin containing a chlorine atom (first binder) and a second thermoplastic resin containing a nitrogen atom (second binder). More specifically, the thermoplastic resin includes a vinyl chloride-based resin and a urethane-based resin. In the present specification, the vinyl chloride-based resin means a polymer containing a structural unit derived from vinyl chloride. More specifically, for example, the vinyl chloride-based resin means a homopolymer of vinyl chloride, a polymer of vinyl chloride and a comonomer copolymerizable therewith, and a mixture of these polymers.

The vinyl chloride-based resin includes, for example, at least one selected from the group consisting of vinyl chloride, a vinyl chloride-vinyl acetate copolymer, a vinyl chloride-vinylidene chloride copolymer, a vinyl chloride-acrylonitrile copolymer, an acrylic acid ester-vinyl chloride-vinylidene chloride copolymer, and a methacrylic acid ester-vinyl chloride copolymer.

The urethane-based resin means a resin containing a urethane bond in at least a part of a molecular chain constituting the resin, and may be a urethane resin or a copolymer containing a urethane bond in a part of a molecular chain. The urethane-based resin may be obtained, for example, by reacting a polyisocyanate with a polyol. Alternatively, the urethane-based resin may be obtained, for example, by reacting a polyester with a polyol. In the present specification, the urethane-based resin includes those obtained by reaction with a curing agent.

The polyisocyanate includes, for example, at least one selected from the group consisting of diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), and the like. In the present specification, the polyisocyanate means a compound having two or more isocyanate groups in the molecule. The polyisocyanate may be a polyisocyanate contained in the curing agent.

As the polyol, any suitable polyol can be adopted as long as it is a polyol having two or more OH groups. The polyol includes, for example, at least one selected from the group consisting of a polyol having two OH groups (diol), a polyol having three OH groups (triol), a polyol having four OH groups (tetraol), a polyol having five OH groups (pentaol), a polyol having six OH groups (hexaol), and the like. Specifically, the polyol includes, for example, at least one selected from the group consisting of a polyester-based polyol, a polyether-based polyol, a polycarbonate-based polyol, a polyesteramide-based polyol, an acrylate-based polyol, and the like.

The polyester includes, for example, at least one selected from the group consisting of a phthalic acid-based polyester and an aliphatic polyester.

The thermoplastic resin may further include a thermoplastic resin other than the vinyl chloride-based resin and the urethane-based resin. Such a thermoplastic resin includes, for example, at least one selected from the group consisting of vinyl acetate, an acrylic acid ester-acrylonitrile copolymer, an acrylic acid ester-acrylonitrile copolymer, an acrylic acid ester-vinylidene chloride copolymer, a methacrylic acid ester-vinylidene chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene-butadiene copolymer, a polyester resin, an amino resin, a synthetic rubber, and the like.

The thermosetting resin includes, for example, at least one selected from the group consisting of a phenol resin, an epoxy resin, a polyurethane curable resin, a urea resin, a melamine resin, an alkyd resin, a silicone resin, a polyamine resin, a urea formaldehyde resin, and the like.

For the purpose of improving the dispersibility of the magnetic particles, polar functional groups such as —SO₃M, —OSO₃M, —COOM, P═O(OM)₂ (provided that, M in the formula represents a hydrogen atom or an alkali metal such as lithium, potassium, or sodium), a side chain type amine having a terminal group represented by —NR1R2 or —NR1R2R3⁺X⁻, a main-chain amine represented by >NR1R2⁺X⁻ (provided that, R1, R2, and R3 in the formula represent a hydrogen atom or a hydrocarbon group, X⁻ represents halogen element ion such as fluorine, chlorine, bromine, or iodine, an inorganic ion, or an organic ion), —OH, —SH, —CN, and an epoxy group may be introduced into all the above-described binders. The amount of the polar functional groups introduced into the binder is preferably 10⁻¹ mol/g or more and 10⁻⁸ mol/g or less, and more preferably 10⁻² mol/g or more and 10⁻⁶ mol/g or less.

### (Conductive Particles)

Some particles of the conductive particles contained in the magnetic layer 43 may protrude from the magnetic surface to form a plurality of protrusions. Since the plurality of protrusions is formed by the conductive particles, electric resistance of the magnetic surface is reduced, and charging of the magnetic surface can be suppressed. Furthermore, dynamic friction between the head unit 56 and the magnetic surface can be reduced when the magnetic tape MT travels.

The conductive particles are preferably an antistatic agent and a solid lubricant. The conductive particles are preferably particles containing carbon. As the particles containing carbon, for example, at least one selected from the group consisting of carbon particles and hybrid particles can be used, and it is preferable to use carbon particles. The average primary particle size of the conductive particles is preferably 100 nm or less. If the average primary particle size of the conductive particles is 100 nm or less, the content of particles excessively large with respect to the thickness of the magnetic layer 43 is suppressed even in a case where the conductive particles are particles (for example, carbon black and the like) having a large particle size distribution.

As the carbon particles, for example, one or more selected from the group consisting of carbon black, acetylene black, Ketjen black, carbon nanotubes, and graphene can be used, and among these carbon particles, carbon black is preferably used. As the carbon black, for example, SEAST TA manufactured by TOKAI CARBON CO., LTD., #15 and #15HS manufactured by Asahi Carbon Co., Ltd., and the like can be used.

The hybrid particle contains carbon and a material other than carbon. The material other than carbon is, for example, an organic material or an inorganic material. The hybrid particle may be a hybrid particle in which carbon is attached to the surface of the inorganic particle. Specifically, for example, hybrid carbon in which carbon is attached to the surface of silica particles may be used.

### (Lubricant)

The lubricant may be a liquid lubricant. The lubricant includes, for example, at least one selected from a fatty acid and a fatty acid ester, preferably both a fatty acid and a fatty acid ester. The fact that the magnetic layer 43 contains a lubricant, in particular, the fact that the magnetic layer 43 contains both a fatty acid and a fatty acid ester contributes to improvement of traveling stability of the magnetic tape MT. More particularly, since the magnetic layer 43 contains a lubricant and has pores, favorable traveling stability is achieved. The improvement of the traveling stability is considered to be because the coefficient of dynamic friction of the surface of the magnetic tape MT on the magnetic layer 43 side is adjusted to a value suitable for traveling of the magnetic tape MT by the above-described lubricant.

The fatty acid may be preferably a compound represented by the following General Formula (1) or (2). For example, one or both of the compound represented by the following General Formula (1) and the compound represented by the following General Formula (2) may be contained as the fatty acid.

Furthermore, the fatty acid ester may be preferably a compound represented by the following General Formula (3), (4), or (5). For example, one, two, or three of the compound represented by the following General Formula (3), the compound represented by the following General Formula (4), and the compound represented by the following General Formula (5) may be contained as the fatty acid ester.

In a case where the lubricant contains any one or both of the compound represented by General Formula (1) and the compound represented by General Formula (2), and one, two, or three of the compound represented by General Formula (3), the compound represented by General Formula (4), and the compound represented by General Formula (5), an increase in the coefficient of dynamic friction due to repeated recording or reproduction of the magnetic tape MT can be suppressed.

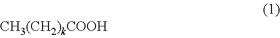

where in General Formula (1), k is an integer selected from a range of 14 or more and 22 or less, and more preferably a range of 14 or more and 18 or less.

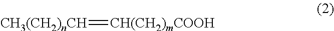

where in General Formula (2), the sum of n and m is an integer selected from a range of 12 or more and 20 or less, and more preferably a range of 14 or more and 18 or less.

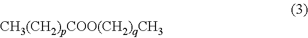

where in General Formula (3), p is an integer selected from a range of 14 or more and 22 or less, and more preferably a range of 14 or more and 18 or less, and q is an integer selected from a range of 2 or more and 5 or less, and more preferably a range of 2 or more and 4 or less.

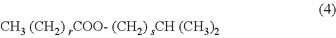

where in General Formula (4), r is an integer selected from a range of 14 or more and 22 or less, and s is an integer selected from a range of 1 or more and 3 or less.

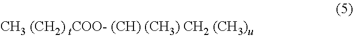

where in General Formula (5), t is an integer selected from a range of 14 or more and 22 or less, and u is an integer selected from a range of 1 or more and 3 or less.

### (Abrasive Particles)

Some particles of the abrasive particles contained in the magnetic layer 43 may protrude from the magnetic surface to form a plurality of protrusions. When the head unit 56 and the magnetic tape MT slide, the protrusions formed by the abrasive particles can come into contact with the head unit 56.

A lower limit value of the Mohs hardness of the abrasive particles is preferably 7.0 or more, more preferably 7.5 or more, still more preferably 8.0 or more, and particularly preferably 8.5 or more from the viewpoint of suppressing deformation due to contact with the head unit 56. An upper limit value of the Mohs hardness of the abrasive particles is preferably 9.5 or less from the viewpoint of suppressing wear of the head unit 56.

The abrasive particles are preferably inorganic particles. Examples of the inorganic particles include α-alumina with a gelatinization rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing magnetic iron oxide raw material, those obtained by performing surface treatment thereon with aluminum and/or silica as necessary, and diamond powder. As the inorganic particles, alumina particles such as α-alumina, β-alumina, and γ-alumina, and silicon carbide are preferably used. The abrasive particles may have any shape such as an acicular shape, a spherical shape, or a dice shape, but those having corners in a part of the shape are preferable because they have high lubricity.

### (Antistatic Agent)

The antistatic agent can reduce the electric resistance of the magnetic surface and suppress charging of the magnetic surface. The antistatic agent contains, for example, at least one selected from the group consisting of a natural surfactant, a nonionic surfactant, a cationic surfactant, and the like.

### (Curing Agent)

The curing agent contains, for example, polyisocyanate and the like. The polyisocyanate includes, for example, diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), or the like as an isocyanate source. The polyisocyanate may have a TMP adduct structure, an isocyanurate structure, a biuret structure, an allophanate structure, or the like.

Specific examples of the polyisocyanate include aromatic polyisocyanates such as an adduct of tolylene diisocyanate (TDI) and an active hydrogen compound, and aliphatic polyisocyanates such as an adduct of hexamethylene diisocyanate (HMDI) and an active hydrogen compound. The weight average molecular weight of these polyisocyanates is desirably in a range of 100 or more and 3000 or less.

### (Rust Inhibitor)

Examples of the rust inhibitor include phenols, naphthols, quinones, heterocyclic compounds containing a nitrogen atom, heterocyclic compounds containing an oxygen atom, and heterocyclic compounds containing a sulfur atom.

### (Non-Magnetic Reinforcing Particles)

Examples of the non-magnetic reinforcing particles include aluminum oxide (α, β, or γ alumina), chromium oxide, silicon oxide, diamond, garnet, emery, boron nitride, titanium carbide, silicon carbide, titanium carbide, and titanium oxide (rutile type or anatase type titanium oxide).

### (Base Layer)

The base layer 42 is for alleviating the uneven shape of the surface of the substrate 41 to adjust the uneven shape of the magnetic surface. The base layer 42 is a non-magnetic layer containing non-magnetic particles, a binder, and a lubricant. The base layer 42 supplies a lubricant to the magnetic surface. The base layer 42 may further contain, as necessary, at least one additive selected from the group consisting of an antistatic agent, a curing agent, a rust inhibitor, and the like.

An upper limit value of an average thickness t₂ of the base layer 42 is preferably 0.90 μm or less, more preferably 0.80 μm or less, still more preferably 0.70 μm or less, and particularly preferably 0.60 μm or less. In a case where the average thickness t₂ of the base layer 42 is 0.90 μm or less, the expansion/contraction property of the magnetic tape MT due to an external force is further enhanced, so that adjustment of the width of the magnetic tape MT by tension adjustment is further facilitated. A lower limit value of the average thickness t₂ of the base layer 42 is preferably 0.30 μm or more from the viewpoint of alleviating the uneven shape on the surface of the substrate 41.

The average thickness t₂ of the base layer 42 is determined in a similar manner to the average thickness tᵢ of the magnetic layer 43. However, the magnification of the TEM image is appropriately adjusted according to the thickness of the base layer 42.

The base layer 42 preferably has a plurality of holes. By causing the plurality of holes to store a lubricant, it is possible to further suppress the decrease in the amount of lubricant supplied between the magnetic surface and the head unit 56 even after repeatedly performing recording or reproduction (that is, even after the head unit 56 is brought into contact with the surface of the magnetic tape MT and repeatedly travels). Thus, an increase in the coefficient of dynamic friction can be further suppressed. That is, more excellent traveling stability can be obtained.

### (Non-Magnetic Particles)

The non-magnetic particles include, for example, at least one of inorganic particles or organic particles. Furthermore, the non-magnetic particles may be carbon particles such as carbon black. Note that one kind of non-magnetic particles may be used alone, or two or more kinds of non-magnetic particles may be used in combination. The inorganic particles include, for example, a metal, a metal oxide, a metal carbonate, a metal sulfate, a metal nitride, a metal carbide, a metal sulfide, or the like. Examples of the shape of the non-magnetic particles include various shapes such as an acicular shape, a spherical shape, a cubic shape, and a plate shape, but are not limited to these shapes.

### (Binder and Lubricant)

The binder and the lubricant are similar to those of the magnetic layer 43 described above.

### (Additive)

The antistatic agent, the curing agent, and the rust inhibitor are similar to those of the magnetic layer 43 described above.

### (Back Layer)

The back layer 44 contains a binder and non-magnetic particles. The back layer 44 may further contain, as necessary, at least one additive selected from the group consisting of a lubricant, a curing agent, an antistatic agent, and the like. The binder and the non-magnetic particles are similar to those of the base layer 42 described above. The curing agent and the antistatic agent are similar to those of the magnetic layer 43 described above.

The average particle size of the non-magnetic particles is preferably 10 nm or more and 150 nm or less, and more preferably 15 nm or more and 110 nm or less. The average particle size of the non-magnetic particles is determined in a similar manner to the average particle size of the magnetic particles described above. The non-magnetic particles may include non-magnetic particles having two or more particle size distributions.

An upper limit value of the average thickness of the back layer 44 is preferably 0.60 μm or less. If the upper limit value of the average thickness of the back layer 44 is 0.60 μm or less, even in a case where the average thickness of the magnetic tape MT is 5.50 μm or less, the thicknesses of the base layer 42 and the substrate 41 can be kept thick, so that the traveling stability of the magnetic tape MT in the recording/reproducing device can be maintained. A lower limit value of the average thickness of the back layer 44 is not particularly limited, and is, for example, 0.20 un or more.

The average thickness t_{b} of the back layer 44 is determined as follows. First, an average thickness t_{T} of the magnetic tape MT is measured. The method of measuring the average thickness t_{T} is as described in the following “Average thickness of magnetic tape”. Subsequently, the magnetic tape MT accommodated in the cartridge 10 is unwound, and the magnetic tape MT is cut out to a length of 250 mm at a position of 30 m to 40 m in the longitudinal direction from one end of the magnetic tape MT on the outer circumferential side, thereby preparing a sample. Next, the back layer 44 of the sample is removed with a solvent such as methyl ethyl ketone (MEK) or dilute hydrochloric acid. Next, a thickness of the sample is measured in five positions using a laser holo gauge (LGH-110C) manufactured by Mitutoyo Corporation, and the measured values are simply averaged (arithmetically averaged) to calculate the average thickness t_{B} [μm]. Thereafter, the average thickness t_{b} [μm] of the back layer 44 is determined by the following formula. Note that the five measurement positions described above are randomly selected from the sample so as to be different positions in the longitudinal direction of the magnetic tape MT.

$${t}_{b} [ μm ] = {t}_{T} [ μm ] - {t}_{B} [ μm ]$$

### (Average Thickness of Magnetic Tape)

An upper limit value of the average thickness (average total thickness) t_{T} of the magnetic tape MT is preferably 5.50 μm or less, more preferably 5.30 μm or less, and still more preferably 5.10 μm or less, 4.90 μm or less, or 4.70 μm or less. In a case where the average thickness t_{T} of the magnetic tape MT is 5.50 μm or less, a recording capacity which can be recorded in one data cartridge may be increased as compared with that in a general magnetic tape. A lower limit value of the average thickness t_{T} of the magnetic tape MT is not particularly limited, and is, for example, 3.50 μm or more.

The average thickness t_{T} of the magnetic tape MT is determined as follows. First, the magnetic tape MT accommodated in the cartridge 10 is unwound, and the magnetic tape MT is cut out to a length of 250 mm at a position of 30 m to 40 m in the longitudinal direction from one end of the magnetic tape MT on the outer circumferential side, thereby preparing a sample. Next, a thickness of the sample is measured in five positions using a laser holo gauge (LGH-110C) manufactured by Mitutoyo Corporation as a measurement device, and the measured values are simply averaged (arithmetically averaged) to calculate the average thickness t_{T} [μm]. Note that the five measurement positions described above are randomly selected from the sample so as to be different positions in the longitudinal direction of the magnetic tape MT.

### (Ratio Hc/Hr)

A ratio Hc/Hr of a coercive force Hc of the magnetic layer 43 in a perpendicular direction of the magnetic tape MT and a residual coercive force Hr of the magnetic layer 43 measured by applying a pulse magnetic field in the perpendicular direction of the magnetic tape MT is 0.45 or less, preferably 0.44 or less, and more preferably 0.43 or less, 0.42 or less, or 0.41 or less. If the ratio Hc/Hr is 0.45 or less, the particle size distribution of the magnetic powder can be sharpened even in a case where the particle volume V_{XRD} of the magnetic powder is 1300 nm³ or less, so that the content of the magnetic nanoparticles that can be non-magnetic in the magnetic layer 43 can be suppressed. Thus, even in a case where the particle volume V_{XRD} of the magnetic powder is 1300 nm³ or less, the electromagnetic conversion characteristics can be improved.

In the measurement of a pulse magnetic field vibrating sample magnetometer (VSM), the residual coercive force Hr depends on an anisotropic magnetic field Hk and does not depend on the particle volume V_{XRD} of the magnetic powder. On the other hand, in the measurement of the VSM, the coercive force Hc depends on the particle volume V_{XRD} of the magnetic powder. In the measurement of the VSM, since the magnetic nanoparticles do not have the coercive force Hc due to thermal fluctuation, the coercive force Hc measured by the VSM is a value not including an element of the magnetic nanoparticles. In the present disclosure, the pulse magnetic field VSM indicates a VSM in which the pulse width of the applied magnetic field is very narrow and the pulse width of the applied magnetic field is on the order of 10⁻⁸ see as compared with a general VSM.

In consideration of the above points, in the magnetic powder in which the content of the magnetic nanoparticles is large and the particle size distribution is broad, the ratio Hc/Hr of Hc measured by the VSM to Hr measured by the pulse magnetic field VSM is large. On the other hand, in the magnetic powder in which the content of the magnetic nanoparticles is small and the particle size distribution is sharp, the above-described ratio Hc/Hr is small. Thus, the sharpness of the particle size distribution of the magnetic powder can be evaluated by the value of the ratio Hc/Hr.

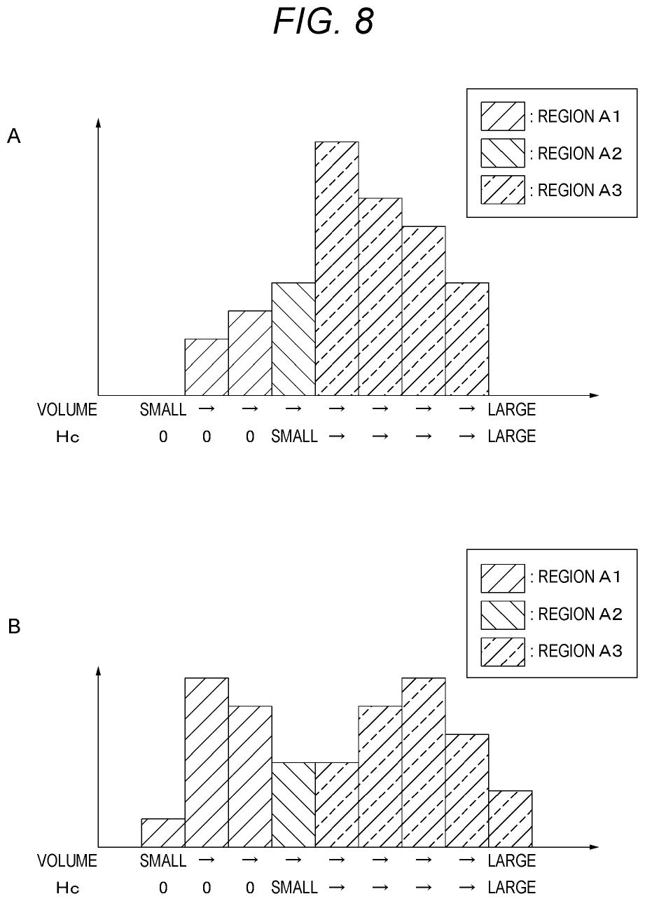

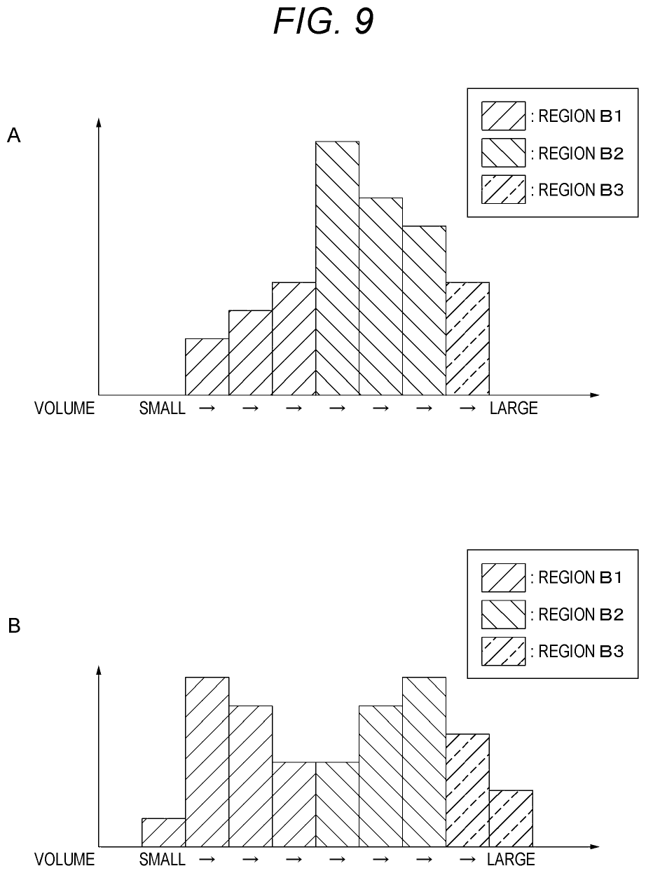

Here, the relationship between the particle distribution of the magnetic powder and the magnetic characteristics as measured by a VSM will be described with reference to FIGS. 8A and 8B. Furthermore, the relationship between the particle distribution of the magnetic powder and the magnetic characteristics as measured by a pulse magnetic field VSM will be described with reference to FIGS. 9A and 9B.

A first particle size distribution shown in FIGS. 8A and 9A represents a particle size distribution of the same magnetic powder, and the first particle size distribution is an example in which the ratio Hc/Hr satisfies 0.45 or less. A second particle size distribution shown in FIGS. 8B and 9B represents a particle size distribution of the same magnetic powder, and the second particle size distribution is an example in which the ratio Hc/Hr exceeds 0.45.

In FIGS. 8A and 8B, magnetic particles included in a region Al, magnetic particles included in a region A2, and magnetic particles included in a region A3 exhibit magnetic characteristics described below during VSM measurement.

Magnetic particles included in the region A1: Due to the influence of thermal fluctuation, it is difficult to measure the coercive force Hc of the magnetic particles during VSM measurement.

Magnetic particles included in the region A2: The coercive force Hc can be measured with difficulty by VSM measurement.

Magnetic particles included in the region A3: The coercive force Hc can be measured by VSM measurement.

Since the magnetic particles included in the region A1 are magnetic particles small enough not to have the coercive force Hc, the magnetic particles hardly contribute to the coercive force Hc of the magnetic layer 43. If the first particle size distribution and the second particle size distribution are compared focusing only on the regions A2 and A3, the second particle size distribution includes many coarse magnetic particles having a coercive force Hc larger than that of the first particle distribution. Therefore, even in a case where the second particle size distribution includes a larger number of magnetic nanoparticles than the first particle distribution, the coercive force Hc of the magnetic layer 43 containing the magnetic powder of the second particle size distribution is apparently larger than the coercive force Hc of the magnetic layer 43 containing the magnetic powder of the first particle size distribution.

In FIGS. 9A and 9B, magnetic particles included in a region B1, magnetic particles included in a region B2, and magnetic particles included in a region B3 exhibit magnetic characteristics described below during the pulse magnetic field VSM measurement.

Magnetic particles included in the region B1: The magnetic particles are magnetized by the pulse magnetic field VSM and contribute to the residual coercive force Hr, but the magnetic particles are magnetized and the magnetization is easily lost after a signal is written, and there is a concern that the magnetic particles become a noise component of a reproduction signal.

Magnetic particles included in the region B2: The magnetic particles are magnetized, and the magnetization is less likely to be lost after a signal is written.

Magnetic particles included in the region B3: Since the coercive force Hc of the magnetic particles is large, it is difficult to write a signal, and there is a concern that the magnetic particles become a noise component of a reproduction signal.

In the case of the pulse magnetic field VSM, since the obtained residual coercive force Hr is hardly affected by thermal fluctuation, the residual coercive force Hr is hardly varied by the particle volume V_{XRD} of the magnetic powder. On the other hand, since the residual coercive force Hr depends on the anisotropic magnetic field Hk, the residual coercive force Hr depending on the shape and type of the magnetic powder, so that normalization with the residual coercive force Hr enables discussion of the particle size distribution regardless of the shape and type of the magnetic powder.

The above-described ratio Hc/Hr is determined as follows.

The coercive force Hc of the magnetic layer 43 is determined as follows. First, the magnetic tape MT accommodated in the cartridge 10 is unwound, and the magnetic tape MT is cut out into six pieces at a position of 30 m to 40 in the longitudinal direction from one end of the magnetic tape MT on the outer circumferential side. At this time, marking is performed with an arbitrary ink having no magnetism so that the longitudinal direction (traveling direction) of the magnetic tape MT. Next, three cut pieces of the magnetic tape MT are stacked with a double-sided tape such that the longitudinal directions of the three cut pieces are the same, and then punched with a φ6.39 mm punch to prepare a measurement sample. Next, an M-H loop of the measurement sample (the entire magnetic tape MT) along the perpendicular direction of the magnetic tape MT (the perpendicular direction of the magnetic tape MT) is measured using a vibrating sample magnetometer (VSM). Next, the coating films (the base layer 42, the magnetic layer 43, the back layer 44, and the like) of the remaining three cut pieces of the magnetic tape MT are wiped off with acetone, ethanol, or the like to leave only the substrate 41. Then, three pieces of the obtained substrate 41 are stacked with a double-sided tape, and then punched out with a 96.39 mm punch to prepare a sample for background correction (hereinafter, simply referred to as “sample for correction”). Thereafter, the M-H loop of the sample for correction (substrate 41) along the perpendicular direction of the substrate 41 (the perpendicular direction of the magnetic tape MT) is measured using a VSM.

In the measurement of the M-H loop of the measurement sample (the entire magnetic tape MT) and the M-H loop of the sample for correction (substrate 41), a highly sensitive vibrating sample magnetometer “VSM-P7-15 Type” manufactured by Toei Industry Co., Ltd. is used. The measurement conditions are as follows: measurement mode: full loop, maximum magnetic field: 15 kOe, magnetic field step: 40 bits, Time constant of Locking amp: 0.3 sec, Waiting time: 1 sec, and MH average number: 20.

After the M-H loop of the measurement sample (the entire magnetic tape MT) and the M-H loop of the sample for correction (substrate 41) are obtained, the M-H loop of the sample for correction (substrate 41) is subtracted from the M-H loop of the measurement sample (the entire magnetic tape MT) to perform background correction, and an M-H loop after the background correction is obtained. For the calculation of the background correction, a measurement/analysis program attached to “VSM-P7-15 Type” is used. The coercive force Hc is determined from the obtained M-H loop after the background correction. For the calculation, a measurement/analysis program attached to “VSM-P7-15 Type” is used. Note that both M-H loops described above are measured at 25° C.±2° C. and 50% RH±5% RH. Furthermore, it is assumed that “demagnetizing field correction” in measuring the M-H loop in the longitudinal direction of the magnetic tape MT is not performed.

The residual coercive force Hr of the magnetic layer 43 is determined as follows. As a measurement sample, a sample similar to the sample used to calculate the coercive force Hc described above is prepared, and a residual magnetization curve in a direction perpendicular to the film surface is obtained as follows using a fast response characteristic evaluation device HR-PVSM20 (pulse magnetic field VSM) manufactured by HAYAMA Inc. First, a magnetic field in the perpendicular direction of about −3980 kA/m (−50 kOe) is applied to the measurement sample, and the magnetic field is returned to zero, thereby creating a residual magnetization state. Thereafter, a magnetic field of about 40.2 kA/m (about 505 Oe) is applied in an opposite direction and the magnetic field is returned to zero again to measure a residual magnetization amount. The applied magnetic field at this time is a pulse magnetic field having a pulse width on the order of 10⁻⁸ sec. Thereafter, similarly, measurement of applying a magnetic field larger than the previously applied magnetic field by about 40.2 kA/m and returning the magnetic field to zero is repeated, and the residual magnetization amount is plotted with respect to the applied magnetic field to create a residual magnetization curve (DCD curve). The measurement magnetic field is up to about 20 kOe. Note that background correction and demagnetizing field correction are not performed. The measurement conditions are shown below.
Initial magnetization voltage: 220 V (corresponding to −3980 kA/m)
Measurement starting voltage: 0 V (corresponding to 0 Oe) Step voltage: 17.5 V (corresponding to about 505 Oe)
Maximum voltage: 350 V (corresponding to 20 kOe)
Wait time of lock-in amplifier: 10 sec

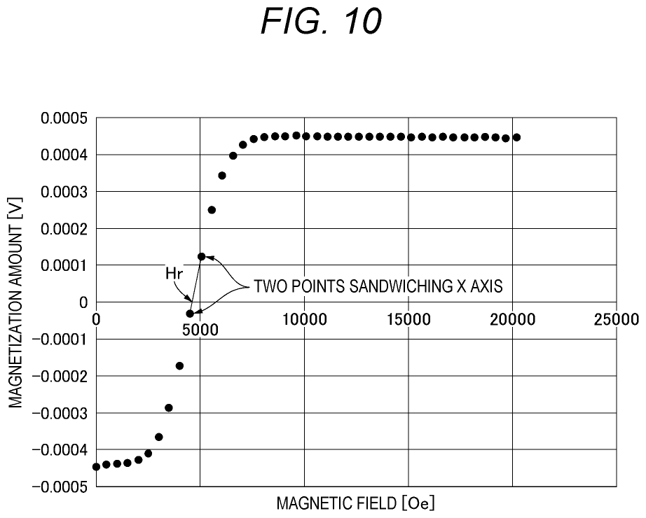

From the data obtained by the measurement as described above, for example, a residual magnetization curve as shown in FIG. 10 is obtained. In order to obtain the residual magnetization curve from the data, phase correction is performed as necessary. The phase correction will be described later. Among points forming the obtained residual magnetization curve, two points sandwiching the X axis (two points closest to the X axis) are connected by a straight line, and a point at which the straight line intersects the X axis is calculated as Hr.

The phase correction will be described in more detail below.

Although the unit of the magnetization amount is originally emu, the magnetization amount at each applied magnetic field is output as a voltage V and either positive or negative value of the magnetization amount (voltage V) at each applied magnetic field is output as a positive value regarding the above-described fast response characteristic evaluation device. Therefore, it is necessary to perform correction according to the phase at each applied magnetic field. For the correction, the phase information data included in the output result by the above-described fast response characteristic evaluation device is used. The phase information data is also output for each applied magnetic field together with the magnetization amount (voltage V) at each applied magnetic field.

In a case where the phase information data of the magnetization amount (voltage V) measured for a certain magnetic field is a negative value, the measured magnetization amount (voltage V) needs to be multiplied by “−1”, and a value obtained by multiplying the measured magnetization amount (voltage V) by “−1” is used to obtain the above-described residual magnetization curve. The processing of multiplying by “−1” is the above-described phase correction.

Meanwhile, in a case where the phase information data of the magnetization amount (voltage V) measured for a certain magnetic field is a positive value, the measured magnetization amount (voltage V) needs not be multiplied by “−1”, and the measured magnetization amount (voltage V) is used as it is to obtain the above-described residual magnetization curve.

By plotting the magnetization amount after phase correction obtained as described above (multiplied by “−1”) and the measured magnetization amount (not multiplied by “−1”) with respect to the magnetic field, the residual magnetization curve as shown in FIG. 10 is obtained.

The ratio Hc/Hr is determined using the coercive force Hc of the magnetic layer 43 and the residual coercive force Hr of the magnetic layer 43 obtained as described above.

### (Coercive Force Hc)

An upper limit value of the coercive force Hc of the magnetic layer 43 in the perpendicular direction of the magnetic tape MT is preferably 3000 Oe or less, and more preferably 2500 Oe or less. In a case where the coercive force Hc is 3000 Oe or less, an increase in magnetic particles (for example, coarse magnetic particles) having an excessively high coercive force Hc can be suppressed, so that an increase in magnetic particles in which signal recording is difficult can be suppressed. Thus, noise of a reproduction signal is reduced, and electromagnetic conversion characteristics can be improved.

A lower limit value of the coercive force Hc of the magnetic layer 43 in the perpendicular direction of the magnetic tape MT is preferably 1500 Oe or more, and more preferably 1700 Oe or more. In a case where the coercive force Hc is 1500 Oe or more, an increase in magnetic particles (for example, magnetic nanoparticles) having an excessively low coercive force Hc can be suppressed, so that an increase in magnetic particles in which magnetization is difficult to maintain due to thermal fluctuation can be suppressed. Thus, noise of a reproduction signal is reduced, and electromagnetic conversion characteristics can be improved.

The numerical range of the coercive force Hc of the magnetic layer 43 may be defined by any of the above-described upper limit values and any of the above-described lower limit values, and is preferably 1500 Oe or more and 3000 Oe or less, and more preferably 1700 Oe or more and 2500 Oe or less.

The method of measuring the coercive force Hc of the magnetic layer 43 is as described in the method of measuring the ratio Hc/Hr described above.

### (Residual Coercive Force Hr)

An upper limit value of the residual coercive force Hr of the magnetic layer 43 measured by applying a pulse magnetic field in the perpendicular direction of the magnetic tape MT is preferably 5200 Oe or less, more preferably 5000 Oe or less, and still more preferably 4800 Oe or less. In a case where the residual coercive force Hr is 5200 Oe or less, an increase in magnetic particles (for example, coarse magnetic particles) having an excessively high residual coercive force Hr can be suppressed, so that an increase in magnetic particles in which signal recording is difficult can be suppressed. Thus, noise of a reproduction signal is reduced, and electromagnetic conversion characteristics can be improved.

A lower limit value of the residual coercive force Hr of the magnetic layer 43 measured by applying a pulse magnetic field in the perpendicular direction of the magnetic tape MT is preferably 3000 Oe or more. In a case where the residual coercive force Hr is 3000 Oe or more, an increase in magnetic particles having an excessively low residual coercive force Hr can be suppressed, so that an increase in magnetic particles (for example, magnetic nanoparticles) in which magnetization is difficult to maintain due to thermal fluctuation can be suppressed. Thus, noise of a reproduction signal is reduced, and electromagnetic conversion characteristics can be improved.

The numerical range of the residual coercive force Hr of the magnetic layer 43 may be defined by any of the above-described upper limit values and any of the above-described lower limit values, and is preferably 3000 Oe or more and 5200 Oe or less, more preferably 3000 Oe or more and 5000 Oe or less, and still more preferably 3000 Oe or more and 4800 Oe or less.

The method of measuring the residual coercive force Hr of the magnetic layer 43 is as described in the method of measuring the ratio Hc/Hr described above.

### (Saturation Magnetic Field Hs)

An upper limit value of the saturation magnetic field Hs of the magnetic layer 43 measured by applying a pulse magnetic field in the perpendicular direction of the magnetic tape MT is preferably 9200 Oe or less. In a case where the saturation magnetic field Hs of the magnetic layer 43 is 9200 Oe or less, an increase in magnetic particles having an excessively high saturation magnetic field Hs (for example, coarse magnetic particles) can be suppressed, and an increase in magnetic particles in which signal recording is difficult can be suppressed. Thus, noise of a reproduction signal is reduced, and electromagnetic conversion characteristics can be improved. A lower limit value of the saturation magnetic field Hs of the magnetic layer 43 measured by applying a pulse magnetic field in the perpendicular direction of the magnetic tape MT is, for example, 3000 Oe or more.

The saturation magnetic field Hs is determined as follows. First, the residual magnetization curve of the magnetic layer 43 is determined in a similar manner to the method of measuring the ratio Hc/Hr described above. Next, a value of the magnetic field when the magnetization is saturated is calculated as the saturation magnetic field Hs.

### (PSD)

In the magnetic layer 43, a power spectrum density (PSD) up to a spatial wavelength of 5 μm is preferably 1.33 nm² or less, more preferably 1.25 nm² or less, and still more preferably 1.15 nm² or less. In a case where the PSD up to a spatial wavelength of 5 μm is 1.33 nm² or less, the magnetic surface is smooth, so that spacing loss between the head unit 56 and the magnetic surface can be suppressed. Thus, electromagnetic conversion characteristics can be improved.

The PSD up to the spatial wavelength of 5 μm is determined as follows. First, the magnetic surface of the magnetic tape MT is observed with an atomic force microscope (AFM) to obtain two-dimensional (2D) surface profile data.

Hereinafter, the AFM used for measuring the magnetic surface will be described.
Device: AFM Dimension 3100 microscope (with NanoscopeIV controller) (Digital Instruments, USA)
Cantilever: NCH-10T (NanoWorld Corporation)

The measurement conditions of the AFM are as follows.
Measurement area: 40 μm×40 μm
Resolution: 256×256
Scan direction of AFM probe: MD direction (longitudinal direction) of the magnetic tape MT
Measurement mode: tapping mode
Scan ratio: 1 Hz

Next, the 2D surface profile data having been obtained by AFM is subjected to the following filter treatment.
Flatten: 3rd order
Planefit: 3rd order only in the MD direction

Next, the MD direction of the 2D surface profile data after the filter treatment is subjected to fast Fourier transform (FFT) in each of 256 lines to acquire 256 power spectrum densities (PSDs). Next, the acquired 256 PSDs in the MD direction are averaged for each wavelength to obtain one averaged PSD (hereinafter, referred to as “PSD(k)_{MD}”) in the MD direction. Note that the following Formula (1) is used for averaging the PSD in the MD direction.

$$[ Math . 2 ]$$

$${PSD ( k )}_{MD} = {( \frac{2 d}{N} {\vert {\sum }_{n = 0}^{N - 1} z ( n ) \cdot {e}^{( \frac{2 π ikn}{N} )} \vert}^{2} )}_{average}$$

PSD: power spectrum density (nm³)
z(n): surface profile data (nm) at n-th point
d: resolution (nm)=L/N
L: measurement range (30 μm) in X-axis direction (or Y-axis direction)
N: number of points in X-axis direction (256 points)
i: imaginary unit
e: Napier's constant
Average: averaging operation in Y-axis direction (or X-axis direction)
n: variable (0 to N−1)
k: wavenumber (0 to N−1)

Note that the X-axis direction corresponds to the MD direction (longitudinal direction).

Out of PSD values at wavelengths obtained so far, one obtained by integrating PSD values at wavelengths of 5 μm or less is adopted.

### (Squareness Ratio)

A squareness ratio S1 of the magnetic layer 43 in the perpendicular direction of the magnetic tape MT is preferably 62% or more, more preferably 65% or more, and still more preferably 68% or more, 72% or more, or 75% or more. In a case where the squareness ratio S1 is 62% or more, the perpendicular orientation of the magnetic particles is sufficiently high, so that more excellent electromagnetic conversion characteristics can be obtained.

The squareness ratio S1 of the magnetic tape MT in the perpendicular direction is determined as follows. First, an M-H loop after the background correction is obtained in a similar manner to the method of measuring Hc described above. The saturation magnetization Ms (emu) and the residual magnetization Mr (emu) of the obtained M-H loop after the background correction are substituted into the following formula to calculate the squareness ratio S1 (%). Note that for the calculation, a measurement/analysis program attached to “VSM-P7-15 Type” is used.

$$Squareness ratio S 1 ( \% ) = ( Mr / Ms ) \times 100$$

A squareness ratio S2 of the magnetic layer 43 in the longitudinal direction (traveling direction) of the magnetic tape MT is preferably 35% or less, more preferably 30% or less, and still more preferably 25% or less, 20% or less, or 15% or less. In a case where the squareness ratio S2 is 35% or less, the perpendicular orientation of the magnetic particles is sufficiently high, so that more excellent electromagnetic conversion characteristics can be obtained. Note that one of the squareness ratio S1 of the magnetic layer 43 in the perpendicular direction of the magnetic tape MT and the squareness ratio S2 of the magnetic layer 43 in the longitudinal direction (traveling direction) of the magnetic tape MT may be within the above-described preferable range, and the other may be out of the above-described preferable range. Alternatively, both the squareness ratio S1 of the magnetic layer 43 in the perpendicular direction of the magnetic tape MT and the squareness ratio S2 of the magnetic layer 43 in the longitudinal direction (traveling direction) of the magnetic tape MT may be within the above-described preferable range.

The squareness ratio S2 in the longitudinal direction of the magnetic tape MT is determined in a similar manner to the squareness ratio S1 except that the M-H loop is measured in the longitudinal direction (traveling direction) of the magnetic tape MT and the substrate 41.

### (Ratio Hc2/Hc1)

A ratio Hc2/Hc1 of a coercive force Hc1 of the magnetic layer 43 in the perpendicular direction of the magnetic tape MT and a coercive force Hc2 of the magnetic layer 43 in the longitudinal direction of the magnetic tape MT satisfies a relationship of preferably Hc2/Hc1 0.8, more preferably Hc2/Hc1≤0.75, and still more preferably Hc2/Hc1≤0.7, Hc2/Hc1≤0.65, or Hc2/Hc1≤0.6. In a case where the coercive forces Hc1 and Hc2 satisfy the relationship of Hc2/Hc1≤0.8, the degree of perpendicular orientation of the magnetic particles can be increased. Thus, a magnetization transition width is reduced, and a high output signal can be obtained at the time of signal reproduction, so that more excellent electromagnetic conversion characteristics can be obtained. Note that as described above, in a case where Hc2 is small, magnetization reacts with high sensitivity due to a magnetic field in the perpendicular direction from a recording head.

In a case where the ratio Hc2/Hc1 is Hc2/Hc1≤0.8, it is particularly effective that the average thickness t₁ of the magnetic layer 43 is 90 nm or less. In a case where the average thickness tᵢ of the magnetic layer 43 exceeds 90 nm, in a case where a ring type head is used as a recording head, a lower region (region on the base layer 42 side) of the magnetic layer 43 is magnetized in the longitudinal direction of the magnetic tape MT, and there is a concern that the magnetic layer 43 cannot be uniformly magnetized in the thickness direction. Therefore, even if the ratio Hc2/Hc1 is set to Hc2/Hc1≤0.8 (that is, even if the degree of perpendicular orientation of the magnetic particles is increased), there is a concern that more excellent electromagnetic conversion characteristics cannot be obtained.

A lower limit value of Hc2/Hc1 is not particularly limited, and is, for example, 0.5≤Hc2/Hc1. Note that Hc2/Hc1 represents the degree of perpendicular orientation of the magnetic particles, and as Hc2/Hc1 is smaller, the degree of perpendicular orientation of the magnetic particles is higher.

The method of calculating the coercive force Hc1 of the magnetic layer 43 in the perpendicular direction of the magnetic tape MT is as described above. The coercive force Hc2 of the magnetic layer 43 in the longitudinal direction of the magnetic tape MT is determined in a similar manner to the coercive force Hc1 of the magnetic layer 43 in the perpendicular direction of the magnetic tape MT except that the M-H loop is measured in the longitudinal direction of the magnetic tape MT and the substrate 41.

### (Activation Volume V_{act})

An activation volume V_{act} is preferably 8000 nm³ or less, more preferably 6000 nm³ or less, and still more preferably 5000 nm³ or less, 4000 nm³ or less, or 3000 nm³ or less. In a case where the activation volume V_{act} is 8000 nm³ or less, a dispersed state of magnetic particles is favorable, so that a bit inversion region can be made steep, and it is possible to suppress deterioration of a magnetization signal recorded in an adjacent track due to a leakage magnetic field from a recording head. Thus, there is a concern that more excellent electromagnetic conversion characteristics cannot be obtained.

The activation volume V_{act} described above is determined by the following formula derived by Street&Woolley.

$${V}_{act} ( {nm}^{3} ) = {k}_{B} \times T \times {X}_{irr} / ( {μ}_{0} \times Ms \times S )$$

where k_{B}: Boltzmann's constant (1.38×10⁻²³ J/K), T: temperature (K), Xᵢᵣᵣ: irreversible magnetic susceptibility, μ₀: vacuum magnetic permeability, S: magnetic viscosity coefficient, Ms: saturation magnetization (emu/cm³)

The irreversible magnetic susceptibility Xᵢᵣᵣ, the saturation magnetization Ms, and the magnetic viscosity coefficient S to be substituted into the above formula are obtained as follows using a VSM. Note that the measurement direction by the VSM is a perpendicular direction (thickness direction) of the magnetic tape MT. Furthermore, the measurement by the VSM is performed at 25° C.±2° C. and 50% RH±5% RH on a measurement sample cut out from the elongated magnetic tape MT. Furthermore, it is assumed that “demagnetizing field correction” in measuring the M-H loop in the perpendicular direction (thickness direction) of the magnetic tape MT is not performed.

### (Irreversible Magnetic Susceptibility Xᵢᵣᵣ)

The irreversible magnetic susceptibility Xᵢᵣᵣ is defined as an inclination near the residual coercive force Hr in the inclination of a residual magnetization curve (DCD curve). First, a magnetic field of −1193 kA/m (15 kOe) is applied to the entire magnetic tape MT, and the magnetic field is returned to zero, thereby achieving a residual magnetization state. Thereafter, a magnetic field of about 15.9 kA/m (200 Oe) is applied in an opposite direction and the magnetic field is returned to zero again to measure a residual magnetization amount. Thereafter, similarly, measurement of applying a magnetic field larger than the previously applied magnetic field by 15.9 kA/m and returning the magnetic field to zero is repeated, and the residual magnetization amount is plotted with respect to the applied magnetic field to measure a DCD curve. From the obtained DCD curve, a point at which the magnetization amount is zero is taken as a residual coercive force Hr, the DCD curve is further differentiated, and the inclination of the DCD curve at each magnetic field is determined. In the inclination of this DCD curve, an inclination near the residual coercive force Hr is Xᵢᵣᵣ.

### (Saturation Magnetization Ms)

First, an M-H loop after the background correction is obtained in a similar manner to the method of measuring the squareness ratio S1 described above. Next, Ms (emu/cm³) is calculated from a value of the saturation magnetization Ms (emu) of the obtained M-H loop and the volume (cm³) of the magnetic layer 43 in the measurement sample. Note that the volume of the magnetic layer 43 is determined by multiplying the area of the measurement sample by the average thickness tᵢ of the magnetic layer 43. The method of calculating the average thickness t₁ of the magnetic layer 43 necessary for calculating the volume of the magnetic layer 43 is as described above.

### (Magnetic Viscosity Coefficient S)

First, a magnetic field of −1193 kA/m (15 kOe) is applied to the entire magnetic tape MT (measurement sample), and the magnetic field is returned to zero, thereby achieving a residual magnetization state. Thereafter, a magnetic field having a value similar to that of the residual coercive force Hr obtained from the DCD curve is applied in the opposite direction. In a state where the magnetic field is applied, the magnetization amount is continuously measured at constant time intervals for 1000 seconds. The relationship between a time t and a magnetization amount M (t) thus obtained is compared with the following formula to calculate a magnetic viscosity coefficient S.

$$M ( t ) = M 0 + S \times ln ( t )$$

where M(t): a magnetization amount at the time t, MO: an initial magnetization amount, S: a magnetic viscosity coefficient, ln(t): a natural logarithm of time.

### (Surface Roughness R_{b} of Back Surface)

A surface roughness of a back surface (surface roughness of the back layer 44) R_{b} preferably satisfies R_{b}≤6.0 [nm]. In a case where the surface roughness R_{b} of the back surface in the above-described range, more excellent electromagnetic conversion characteristics can be obtained.

The surface roughness R_{b} of the back surface is determined as follows. First, the magnetic tape MT accommodated in the cartridge 10 is unwound, and the magnetic tape MT is cut out to a length of 100 mm at a position of 30 m to 40 m in the longitudinal direction from one end of the magnetic tape MT on the outer circumferential side, thereby preparing a sample. Next, the sample is placed on a slide glass so that a surface of the sample to be measured (surface on the magnetic layer 43 side) is directed upward, and an end portion of the sample is fixed with a mending tape. The surface shape is measured using VertScan (objective lens 20 times) as a measurement device, and the surface roughness R_{b} of the back surface is determined from the following formula on the basis of the ISO 25178 standard.

The measurement conditions are as follows.
Device: Non-contact roughness meter using optical interference
(non-contact surface/layer cross-sectional shape measurement system VertScan R5500GL-M100-AC manufactured by Ryoka Systems Inc.)
Objective lens: 20 times
Measurement region: 640×480 pixels (field of view: about 237 μm×178 μm field of view)
Measurement mode: phase
Wavelength filter: 520 nm
CCD: ⅓ inches
Noise removal filter: smoothing 3×3
Surface correction: correction on quadratic polynomial approximated surface
Measurement software: VS-Measure Version 5.5.2
Analysis software: VS-viewer Version 5.5.5

$$[ Math . 3 ]$$

$${S}_{a} = \frac{1}{A} \int {\int }_{A} \vert Z ( x , y ) \vert dxdy$$

After measuring the surface roughness at five positions in the longitudinal direction of the magnetic tape MT as described above, the average value of arithmetic average roughnesses Sₐ (nm) automatically calculated on the basis of the surface profile obtained at each position is taken as the surface roughness R_{b}(nm) of the back surface.

### (Young's Modulus of Magnetic Tape in Longitudinal Direction)

An upper limit value of the Young's modulus of the magnetic tape MT in the longitudinal direction is preferably 9.0 GPa or less, more preferably 8.0 GPa or less, still more preferably 7.5 GPa or less, and particularly preferably 7.1 GPa or less. In a case where the Young's modulus of the magnetic tape MT in the longitudinal direction is 9.0 GPa or less, the expansion/contraction property of the magnetic tape MT due to an external force is further enhanced, so that adjustment of the width of the magnetic tape MT by tension adjustment is further facilitated. Thus, it is possible to further appropriately suppress off-track and further accurately reproduce data recorded in the magnetic tape MT. A lower limit value of the Young's modulus of the magnetic tape MT in the longitudinal direction is preferably 3.0 GPa or more, and more preferably 4.0 GPa or more. In a case where the lower limit value of the Young's modulus of the magnetic tape MT in the longitudinal direction is 3.0 GPa or more, a decrease in traveling stability can be suppressed.

The Young's modulus of the magnetic tape MT in the longitudinal direction is a value indicating the difficulty of expansion and contraction of the magnetic tape MT in the longitudinal direction due to an external force, as this value is larger, the magnetic tape MT is less likely to expand and contract in the longitudinal direction due to an external force, and as this value is smaller, the magnetic tape MT is more likely to expand and contract in the longitudinal direction due to an external force.

Note that the Young's modulus of the magnetic tape MT in the longitudinal direction is a value relating to the magnetic tape MT in the longitudinal direction, and is correlated with the difficulty of expansion and contraction of the magnetic tape MT in the width direction. That is, as this value is larger, the magnetic tape MT is less likely to expand and contract in the width direction due to an external force, and as this value is smaller, the magnetic tape MT is more likely to expand and contract in the width direction due to an external force. Thus, from the viewpoint of tension adjustment, it is advantageous that the Young's modulus of the magnetic tape MT in the longitudinal direction is small as described above and is 9.0 GPa or less.

For measurement of the Young's modulus, a tensile tester (AG-100D manufactured by SHIMADZU CORPORATION). In a case where the Young's modulus in the tape longitudinal direction is desired to be measured, the magnetic tape MT accommodated in the cartridge 10 is unwound, and the magnetic tape MT is cut out to a length of 180 mm at a position of 30 m to 40 m in the longitudinal direction from one end of the magnetic tape MT on the outer circumferential side, thereby preparing a measurement sample. A jig capable of fixing the tape width (½ inches) is attached to the above-described tensile tester to fix the top and bottom of the tape width. The distance (length of the tape between chucks) is set to 100 mm. After chucking the data sample, stress is gradually applied in the direction of pulling the sample. The pulling speed is set to 0.1 mm/min. The Young's modulus is calculated using the following formula on the basis of the change in stress and the elongation amount at this time.

$$E ( N / {m}^{2} ) = ( ( Δ N / S ) / ( Δ x / L ) ) \times {10}^{6}$$

ΔN: change in stress (N)
S: cross-sectional area (mm²) of test piece
Δx: elongation amount (mm)
L: distance (mm) between gripping jigs

The cross-sectional area S of a measurement sample 10S described above is a cross-sectional area before the tensile operation, and is obtained by the product of the width (½ inches) of the measurement sample 10S and the thickness of the measurement sample 105. For the range of the tensile stress at the time of measurement, the range of the tensile stress in the linear region is set according to the thickness of the magnetic tape MT and the like. Here, the range of the stress is set to 0.2 N to 0.7 N, and the stress change (ΔN) and the elongation amount (Δx) at this time are used for calculation. Note that the measurement of the Young's modulus is performed at 25° C.±2° C. and 50% RH±5% RH.

### (Young's Modulus of Substrate in Longitudinal Direction)

The Young's modulus of the substrate 41 in the longitudinal direction is preferably 7.8 GPa or less, more preferably 7.0 GPa or less, still more preferably 6.6 GPa or less, and particularly preferably 6.4 GPa or less. In a case where the Young's modulus of the substrate 41 in the longitudinal direction is 7.8 GPa or less, the expansion/contraction property of the magnetic tape MT due to an external force is further enhanced, so that adjustment of the width of the magnetic tape MT by tension adjustment is further facilitated. Thus, it is possible to further appropriately suppress off-track and further accurately reproduce data recorded in the magnetic tape MT. A lower limit value of the Young's modulus of the substrate 41 in the longitudinal direction is preferably 2.5 GPa or more, and more preferably 3.0 GPa or more. In a case where the lower limit value of the Young's modulus of the substrate 41 in the longitudinal direction is 2.5 GPa or more, a decrease in traveling stability can be suppressed.

The Young's modulus of the substrate 41 in the longitudinal direction described above is determined as follows. First, the magnetic tape MT accommodated in the cartridge 10 is unwound, and the magnetic tape MT is cut out to a length of 180 mm at a position of 30 m to 40 m in the longitudinal direction from one end of the magnetic tape MT on the outer circumferential side. Subsequently, the base layer 42, the magnetic layer 43, and the back layer 44 are removed from the cut magnetic tape MT to obtain the substrate 41. Using the substrate 41, the Young's modulus of the substrate 41 in the longitudinal direction is determined in a similar procedure to the Young's modulus of the magnetic tape MT in the longitudinal direction described above.

The thickness of the substrate 41 occupies half or more of the entire thickness of the magnetic tape MT. Thus, the Young's modulus of the substrate 41 in the longitudinal direction is correlated with the difficulty of expansion and contraction of the magnetic tape MT due to an external force, as this value is larger, the magnetic tape MT is less likely to expand and contract in the width direction due to an external force, and as this value is smaller, the magnetic tape MT is more likely to expand and contract in the width direction due to an external force.

Note that the Young's modulus of the substrate 41 in the longitudinal direction is a value relating to the magnetic tape MT in the longitudinal direction, and is correlated with the difficulty of expansion and contraction of the magnetic tape MT in the width direction. That is, as this value is larger, the magnetic tape MT is less likely to expand and contract in the width direction due to an external force, and as this value is smaller, the magnetic tape MT is more likely to expand and contract in the width direction due to an external force. Thus, from the viewpoint of tension adjustment, it is advantageous that the Young's modulus of the substrate 41 in the longitudinal direction is small as described above and is 7.8 GPa or less.

### 5 METHOD FOR MANUFACTURING MAGNETIC POWDER

Next, an example of a method for manufacturing a magnetic powder will be described. The method for manufacturing a magnetic powder uses a so-called glass crystallization method.

### (Raw Material Mixing Step)

First, a hexagonal ferrite-forming component (magnetic powder raw material) and a glass forming component (glass raw material) are mixed. For example, a magnetic body raw material containing the hexagonal ferrite-forming component and the glass forming component is put in a container such as plastic container, and then mixed for a predetermined time (for example, 60 minutes) by a powder mixer.

The glass forming component is a glass raw material that exhibits a glass transition phenomenon and can be amorphized, that is, a glass raw material that can be vitrified. The glass forming component contains, for example, at least one of sodium tetraborate (Na₂B₄O₇) or boric acid (B₂O₃).

The hexagonal ferrite-forming component is a compound containing an atom to be a constituent atom of a crystal structure of hexagonal ferrite, and includes, for example, metal carbonate and iron oxide. The metal carbonate includes at least barium carbonate (BaCO₃). The metal carbonate may further include strontium carbonate (SrCO₃). The iron oxide includes, for example, ferric oxide (Fe₂O₃). The content ratio of SrCO₃ in the hexagonal ferrite-forming component is preferably higher than the content ratio of iron oxide in the hexagonal ferrite-forming component.

The content ratio of various components in the raw material mixture is determined according to the composition of hexagonal ferrite particles to be obtained. For example, the content ratio of the glass forming component in the raw material mixture is 30 mol % or less. The raw material mixture can be prepared by weighing various components and then mixing them.

At the time of the mixing, an oxide of a metal M2 may be further mixed as necessary. The oxide of the metal M2 includes, for example, at least one selected from the group consisting of titanium oxide (TiO₂), aluminum oxide (Al₂O₃), neodymium oxide (Nd₂O₃), and the like.

### (Melting Step)

Next, the raw material mixture is melted to obtain a melt. The raw material mixture can be melted by, for example, a glass melting furnace. for example, the raw material mixture is charged into a crucible of the glass melting furnace and melted at a melting temperature of, for example, 1300° C. or higher and 1500° C. or lower. The melting time is only required to be appropriately set so that the raw material mixture is sufficiently melted. The melting time can be, for example, 80 minutes, for example, in a case where 1 kg of the raw material mixture is charged into the glass melting furnace. Furthermore, it is preferable that the raw material mixture in the melting furnace is melted while being stirred by a stirring device. This is because temperature unevenness in the melting furnace is reduced, and amorphization of the melt formed by melting the raw material mixture is promoted. In a case where the content ratio of the glass raw material in the raw material mixture is reduced to, for example, 30 mol % or less, the content ratio of the component containing iron oxide (Fe₂O₃) becomes relatively high. In this case, since the melting point of the raw material mixture increases, the stirring operation is important in order to homogenize the temperature distribution in the furnace and eliminate the unevenness of melting. Furthermore, when the melt is discharged from the melting furnace by stirring, the melt can be prevented from clogging a discharge port. The stirring device may stir at a rotation speed of, for example, 30 rpm or more.

### (Rapid Cooling Step)

Next, the melt obtained by melting the raw material mixture is rapidly cooled to produce an amorphous body containing an amorphous component. The rapid cooling can be performed in a similar manner to the rapid cooling step that is usually performed to obtain an amorphous body by a glass crystallization method. For example, a method of rapidly cooling the melt while rolling the melt using a pair of cooling rolls rotating at a high speed is preferable. In the pair of cooling rolls, for example, the temperature of the surface is preferably kept constant by circulating cooling water through an internal flow path. This is for stabilizing the rapid cooling efficiency and promoting amorphization of the melt. The temperature of the surface of the cooling roll is set to, for example, 20° C. Furthermore, an interval between the pair of cooling rolls is, for example, 1 mm or less, and the discharge speed is, for example, 0.5 g/sec or more and 1.0 g/sec or less. Note that the term “rapid cooling” means that the molten raw material mixture is rapidly cooled to around room temperature to bring the melt into a disordered state (hereinafter, referred to as an amorphous state). In order to achieve an amorphous state, it is considered that one condition is that the cooling rate exceeds the crystal growth rate. The amorphous state makes it possible to control the growth of nanoparticles and the particle size of nanoparticles. If the cooling rate is lower than the crystal growth rate, crystal growth of the particles occurs before the transition to the amorphous state, and the amorphous state and the crystalline state are mixed in the melt. Thus, in a case where the rapid cooling does not go well and the melt of the raw material mixture is not sufficiently brought into an amorphous state, the amorphous state and the crystalline state are mixed in the melt. Therefore, particles grown from an amorphous state in the subsequent firing step and particles grown from a crystalline state having a certain size in the firing step are mixed in the magnetic powder (hexagonal ferrite magnetic powder). Thus, it is considered that variations occur in particle size distribution and magnetic characteristics of a magnetic powder (hexagonal ferrite magnetic powder) to be obtained.

### (Firing Step)

Next, the amorphous body containing an amorphous component is charged into, for example, an electric furnace and fired. Therefore, a fired body in which the hexagonal ferrite particles and the crystallized glass component are precipitated is obtained. The particle size of the hexagonal ferrite particles to be precipitated can be controlled by firing conditions. Increasing the firing temperature (crystallization temperature) for crystallization leads to an increase in the particle size of the hexagonal ferrite particles to be precipitated. Thus, the temperature is preferably equal to or higher than the temperature at which crystallization of hexagonal ferrite occurs and as low as possible. Specifically, it is preferable to form a crystallized product by firing the amorphous body at a firing temperature of 570° C. or higher and 630° C. or lower. The firing time for crystallization (holding time at the crystallization temperature) is, for example, 1 hour or more and 48 hours or less, and it is desirable to perform the firing for 8 hours or more, for example. Furthermore, the temperature increase rate until reaching the firing temperature is 1.0° C./min or more and 10.0° C./min or less, for example, 5.0° C./min or less. The firing treatment may be performed in one stage, two stages, or three or more stages.

### (Acid Treatment Step)

Next, the fired body is subjected to an acid treatment. Therefore, the glass component surrounding the hexagonal ferrite particles is melted, and the hexagonal ferrite particles are removed. The acid treatment may be performed, for example, by putting the fired body into an acid such as acetic acid and performing ball mill washing. Next, the fired body after the acid treatment is centrifuged by a centrifuge, and then decantation is performed. Therefore, impurities such as a glass component are removed. Note that before the acid treatment, the fired body is preferably pulverized. This is to enhance the efficiency of the acid treatment. The pulverization treatment may be performed by either a dry method or a wet method.

### (Drying Step)

Next, the hexagonal ferrite particles from which the glass component has been removed are washed with water, and then subjected to a drying treatment. As a result, a target magnetic powder is obtained.

In the above-described method for manufacturing a magnetic powder, at least one of Na₂B₄O₇ or B₂O₃ is used as a glass raw material, and the content ratio of at least one of Na₂B₄O₇ or B₂O₃ as a glass raw material in the raw material mixture is set to 30 mol % or less. As described above, by suppressing the content ratio of the glass raw material in the raw material mixture to a low level, the number of nucleating particles as nuclei of hexagonal ferrite particles in the raw material mixture relatively increases. The nucleating particles are, for example, Sr atoms contained in SrCO₃ or Fe atoms contained in Fe₂O₃ as a magnetic body raw material. It is considered that a large number of hexagonal ferrite particles are generated by relatively increasing the number of nucleating particles, and coarsening of individual hexagonal ferrite particles is suppressed. Furthermore, use of at least one of Na₂B₄O₇ or B₂O₃ as a glass raw material has the following advantages as compared with the case of using, for example, H₃B0₃. The boiling point of H₃BO₃ is as very low as 300° C. Therefore, there is a possibility that H₃BO₃ evaporates at the time when the raw material mixture is charged into the melting furnace. Thus, the melting point of the melt increased, and melting is difficult. Since the boiling point of Na₂B₄O₇ is 1575° C. and the boiling point of B₂O₃ is 1680° C., which are relatively high, evaporation of Na₂B₄O₇ hardly occurs at the time when the raw material mixture is charged into the melting furnace. Thus, the melting point of the melt can be suppressed low, and the raw material mixture can be sufficiently melted. Furthermore, by using at least one of Na₂B₄O₇ or B₂O₃, the melt is easily brought into an amorphous state at the time of rapid cooling as compared with the case of using H₃BO₃. Therefore, it is possible to obtain an effect of suppressing variation in particle growth and suppressing coarsening of particles during firing.

Furthermore, in the above-described method for manufacturing a magnetic powder, the content ratio (molar ratio) of SrCO₃ as a magnetic body raw material is set to be higher than the content ratio (molar ratio) of Fe₂O₃ in the magnetic body raw material. That is, the content ratio (molar ratio) of Fe is set to be higher than the content ratio (molar ratio) of Sr. Therefore, a large number of hexagonal ferrite particles are generated. Thus, it is considered that coarsening of individual hexagonal ferrite particles is suppressed. Strontium has a high ionization tendency and dissolves in glass to some extent. Therefore, in a case where the content ratio (molar ratio) of Sr is equal to or less than the content ratio (molar ratio) of Fe, strontium is insufficient, and the number of hexagonal ferrite particles to be generated decreases. As a result, individual hexagonal ferrite particles tend to be coarsened.

### 6 METHOD FOR MANUFACTURING MAGNETIC TAPE

Next, an example of a method for manufacturing the magnetic tape MT having the above-described configuration will be described.

### (Step of Preparing Coating Material)

First, non-magnetic particles, a binder, and the like are kneaded and dispersed in a solvent to prepare a coating material for forming a base layer. Next, magnetic particles, a binder, and the like are kneaded and dispersed in a solvent to prepare a coating material for forming a magnetic layer. For the preparation of the coating material for forming a magnetic layer and the coating material for forming a base layer, for example, the following solvents, dispersing devices, and kneading devices can be used.

Examples of the solvent used for preparing the above-described coating material include ketone-based solvents such as acetone, methyl ethyl ketone, methyl isobutyl ketone, and cyclohexanone, alcohol-based solvents such as methanol, ethanol, and propanol, ester-based solvents such as methyl acetate, ethyl acetate, butyl acetate, propyl acetate, ethyl lactate, and ethylene glycol acetate, ether-based solvents such as diethylene glycol dimethyl ether, 2-ethoxyethanol, tetrahydrofuran, and dioxane, aromatic hydrocarbon-based solvents such as benzene, toluene, and xylene, and halogenated hydrocarbon-based solvents such as methylene chloride, ethylene chloride, carbon tetrachloride, chloroform, and chlorobenzene. These may be used alone or mixed appropriately for use.

As the kneading device used for preparing the above-described coating material, for example, kneading devices such as a continuous twin-screw kneader, continuous twin-screw kneader capable of performing dilution in multi-stages, a kneader, a pressure kneader, and a roll kneader can be used, but the kneading device is not particularly limited to these devices. Furthermore, as the dispersing device used for preparing the above-described coating material, for example, dispersing devices such as a roll mill, a ball mill, a horizontal sand mill, a vertical sand mill, a spike mill, a pin mill, a tower mill, a pearl mill (for example, “DCP mill” manufactured by Nippon Eirich Co., Ltd.), a homogenizer, and an ultrasonic dispersion machine can be used, but the dispersing device is not particularly limited to these devices.

### (Coating Step)

Next, the coating material for forming a base layer is applied to one main surface of the substrate 41 and dried to form the base layer 42. Subsequently, the coating material for forming a magnetic layer is applied onto the base layer 42 and dried to form the magnetic layer 43 on the base layer 42. Note that during drying, the magnetic field of the magnetic particles may be oriented in the thickness direction of the substrate 41 by, for example, a solenoid coil. After the magnetic layer 43 is formed, the back layer 44 is formed on the other main surface of the substrate 41. Therefore, the magnetic tape MT is obtained. Note that the order of formation of the base layer 42, the magnetic layer 43, and the back layer 44 is not limited to the above-described example. For example, after the back layer 44 is formed on the other main surface of the substrate 41, the base layer 42 and the magnetic layer 43 may be sequentially formed on one main surface of the substrate 41.

The squareness ratios S1 and S2 are each set to a desired value by adjusting, for example, the strength of the magnetic field to be applied to the coating material for forming a magnetic layer, the concentration of solid content in the coating material for forming a magnetic layer, and the drying conditions (drying temperature and drying time) of the coating material for forming a magnetic layer. The strength of the magnetic field to be applied to the coating film is preferably 2 times or more and 3 times or less the coercive force of the magnetic particles. In order to further increase the squareness ratio S1 (that is, in order to further decrease the squareness ratio S2), it is preferable to improve the dispersion state of the magnetic particles in the coating material for forming a magnetic layer. Furthermore, in order to further increase the squareness ratio S1, it is also effective to magnetize the magnetic particles at the stage before the coating material for forming a magnetic layer enters an orientation device for causing the magnetic field of the magnetic particles to be oriented. Note that the above-described methods for adjusting the squareness ratios S1 and S2 may be used alone or in combination of two or more.

### (Curing Step)

Next, after the magnetic tape MT is wound into a roll shape, the magnetic tape MT is heated in this state to cure the base layer 42 and magnetic layer 43.

### (Calendar Step)

Next, the obtained magnetic tape MT is calendered to smooth the magnetic surface.

### (Cutting Step)

Next, the magnetic tape MT is cut into a predetermined width (for example, ½ inch width). As a result, the magnetic tape MT is obtained.

### (Servo Writing Step)

Next, after the magnetic tape MT is demagnetized, a servo pattern may be written on the magnetic tape MT as necessary.

### (Method of Adjusting Ratio Hc/Hr)

In the method of adjusting the ratio Hc/Hr, the ratio Hc/Hr can be adjusted to desired values, for example, by adjusting the composition ratio of the raw materials (composition ratio of Sr and Ba) in the step of manufacturing a magnetic powder, the content ratio of the glass forming component in the raw material mixture, and the firing conditions. Examples of the firing conditions include a firing temperature, a firing rate, and a firing time. Preferable ranges of the composition ratio of Sr and Ba, the content ratio of the glass forming component in the raw material mixture, the firing temperature, the firing rate, and the firing time are as described above.

### 7 OPERATION AND EFFECT

As described above, in the magnetic tape MT according to an embodiment, the ratio Hc/Hr of the coercive force Hc of the magnetic layer 43 in the perpendicular direction of the magnetic tape MT and the residual coercive force Hr of the magnetic layer 43 measured by applying a pulse magnetic field in the perpendicular direction of the magnetic tape MT is 0.45 or less. Therefore, the particle size distribution of the magnetic powder can be sharpened even in a case where the particle volume V_{XRD} of the magnetic powder is 1300 nm³ or less, so that the content of the magnetic nanoparticles that can be non-magnetic in the magnetic layer 43 can be suppressed. Thus, even in a case where the particle volume V_{XRD} of the magnetic powder is 1300 nm³ or less, the electromagnetic conversion characteristics can be improved.

### 8 MODIFICATION

In the above-described embodiment, a case where the magnetic tape cartridge is the one-reel-type cartridge 10 has been described, but the magnetic tape cartridge may be a two-reel-type cartridge.

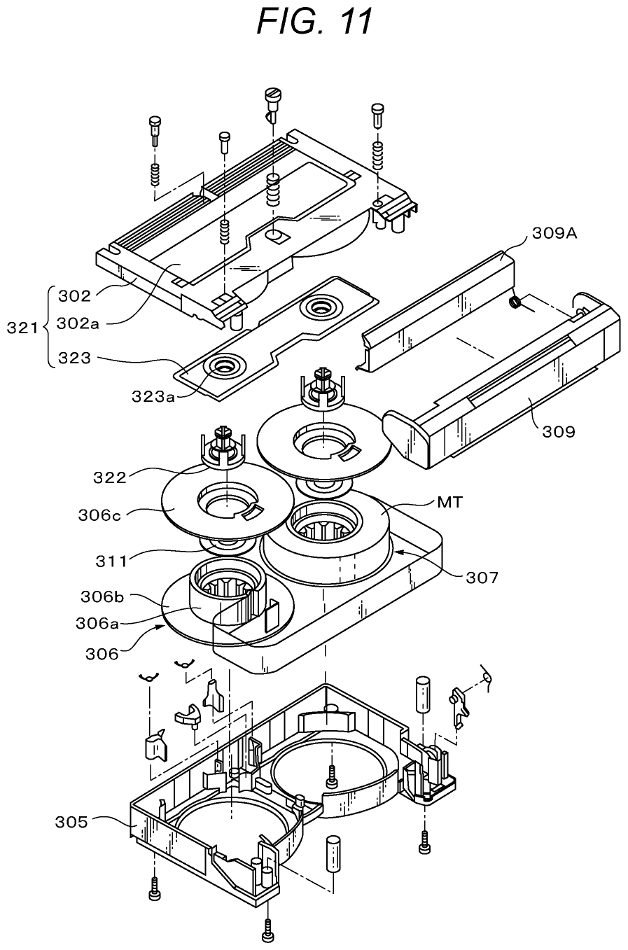

FIG. 11 is an exploded perspective view illustrating an example of a configuration of a two-reel-type cartridge 321. The cartridge 321 includes a synthetic resin upper half 302, a transparent window member 323 fitted and fixed to a window portion 302a opened on the upper surface of the upper half 302, a reel holder 322 fixed to the inside of the upper half 302 to prevent reels 306 and 307 from floating, a lower half 305 corresponding to the upper half 302, the reels 306 and 307 accommodated in a space formed by combining the upper half 302 and the lower half 305, a magnetic tape MT wound around the reels 306 and 307, a front lid 309 closing a front opening formed by combining the upper half 302 and the lower half 305, and a back lid 309A protecting the magnetic tape MT exposed on the front opening.

The reels 306 and 307 are for winding the magnetic tape MT. The reel 306 includes a lower flange 306b having a cylindrical hub portion 306a around which the magnetic tape MT is wound in the center thereof, an upper flange 306c having substantially the same size as the lower flange 306b, and a reel plate 311 sandwiched between the hub portion 306a and the upper flange 306c. The reel 307 has a configuration similar to that of the reel 306.

The window member 323 is provided with attachment holes 323a for assembling the reel holder 322, which is a reel holding means prevention the reels from floating, at positions corresponding to the reels 306 and 307, respectively. The magnetic tape MT is similar to the magnetic tape MT in a first embodiment.

### 9 EXAMPLES

Hereinafter, the present disclosure will be specifically described with reference to Examples, but the present disclosure is not limited to these Examples.

In the following Examples and Comparative Examples, the average thickness of the magnetic tape, the average thickness of the magnetic layer, the average thickness of the base layer, the average thickness of the back layer, and the average thickness of the base film (substrate) shown in Table 2 are values determined by the measurement methods described in the embodiment described above.

In the following Examples and Comparative Examples, the particle volume V_{XRD} of the magnetic powder shown in Table 3 is a value determined by the measurement method described in the embodiment described above.

### Example 1

### <Step of Preparing Magnetic Powder>

A magnetic powder was prepared by the following steps.

### (Raw Material Mixing Step)

First, sodium tetraborate (Na₂B₄O₇), barium carbonate (BaCO₃), iron oxide (Fe₂O₃), titanium oxide (TiO₂), and aluminum oxide (Al₂O₃) were weighed so as to have the mixing ratio shown in Table 1, and these were mixed with a powder mixer to obtain a raw material mixture. The mixing time was 60 minutes.

### (Melting Step)

Next, 1 kg of the raw material mixture was charged into a crucible of a glass melting furnace and melted to obtain a melt. The melting temperature was set to 1400° C., and the melting time was set to 80 minutes. At the time of dissolution, the raw material mixture placed in the crucible was stirred with a stirring rod rotating at 30 rpm.

### (Rapid Cooling Step)

Next, the melt was rapidly cooled while flowing out from the crucible to produce an amorphous body containing an amorphous component. Here, the melt was rapidly cooled while being rolled using a pair of cooling rolls having a surface temperature set to 20° C. At this time, an interval between the pair of cooling rolls was set to 1 mm or less, and the discharge speed was set to 0.5 g/sec or more and 1.0 g/sec or less.

### (Firing Step)

Next, the amorphous body obtained by rapid cooling was put into an electric furnace and fired. The firing treatment was performed as shown below. The firing temperature was set to 620° C., and the temperature increase rate from room temperature to the firing temperature was set to 5.0° C./min. Furthermore, the firing temperature of 620° C. was maintained for 8 hours (firing time) from the time point when the firing temperature reached 620° C. Therefore, a crystallized product containing barium ferrite particles was obtained.

### (Acid Treatment Step)

Next, the obtained fired body was subjected to an acid treatment to remove the glass component, thereby extracting strontium ferrite particles. For the acid treatment, acetic acid was used, and ball mill washing was performed. Thereafter, centrifugation was performed with a centrifuge, and decantation was performed to obtain a barium ferrite magnetic powder.

### (Drying Step)

Finally, the barium ferrite magnetic powder was charged into an electric furnace and dried in an environment of 120° C. until the moisture value of the magnetic powder reached 2.0 (wt %) or less. Therefore, a target barium ferrite magnetic powder (hexagonal ferrite magnetic powder) was obtained.

### <Step of Preparing Magnetic Tape>

The magnetic tape was prepared by the following steps.

### (Step of Preparing Coating Material for Forming Magnetic Layer)

A coating material for forming a magnetic layer was prepared as follows. First, a first composition having the following formulation was kneaded with an extruder. Note that as a barium ferrite magnetic powder in the first composition, the barium ferrite magnetic powder prepared as described above was used. Next, the kneaded first composition and a second composition having the following formulation were added to a stirring tank equipped with a disper, and premixing was performed. Subsequently, dyno mill mixing was further performed and filter treatment was performed to prepare a coating material for forming a magnetic layer.

### (First Composition)

Barium ferrite magnetic powder (hexagonal plate-shaped): 100.00 parts by mass
Vinyl chloride-based resin solution: 50.00 parts by mass (formulation of resin solution: vinyl chloride-based resin 30 mass %, cyclohexanone solution 70 mass %) (vinyl chloride-based resin: degree of polymerization 300, Mn=10000, containing OSO₃K=0.07 mmol/g and secondary OH=0.3 mmol/g as polar groups)
Aluminum oxide powder: 7.50 parts by mass (α-Al₂O₃, average particle size 90 nm)

### (Second Composition)

Carbon black: 2.00 parts by mass (product name: SEAST TA manufactured by TOKAI CARBON CO., LTD.)
Polyurethane resin solution: 5.56 parts by mass (formulation of resin solution: blending amount of polyurethane resin 30 mass %, blending amount of cyclohexanone 70 mass %) (polyurethane resin: number average molecular weight Mn=25000, glass transition temperature Tg=110° C.)
n-Butyl stearate: 2 parts by mass
Methyl ethyl ketone: 121.3 parts by mass
Toluene: 121.30 parts by mass
Cyclohexanone: 60.70 parts by mass

Finally, polyisocyanate (product name: Coronate L, manufactured by TOSOH CORPORATION): 3.30 parts by mass and stearic acid: 2.00 parts by mass were added as curing agents to the coating material for forming a magnetic layer prepared as described above.

### (Step of Preparing Coating Material for Forming Base Layer)

A coating material for forming a base layer was prepared as follows. First, a third composition having the following formulation was kneaded with an extruder. Next, the kneaded third composition and a fourth composition having the following formulation were added to a stirring tank equipped with a disper, and premixing was performed. Subsequently, dyno mill mixing was further performed and filter treatment was performed to prepare a coating material for forming a base layer.

### (Third Composition)

Acicular iron oxide powder: 100.00 parts by mass (α-Fe₂O₃, average major axis length 0.12 μm)
Vinyl chloride-based resin solution: 46.00 parts by mass (formulation of resin solution: vinyl chloride-based resin 30 mass %, cyclohexanone solution 70 mass %) (vinyl chloride-based resin: degree of polymerization 300, Mn=10000, containing OSO₃K=0.07 mmol/g and secondary OH=0.3 mmol/g as polar groups)

### (Fourth Composition)

Carbon black: 25.00 parts by mass
Polyurethane resin solution: 36.00 parts by mass (formulation of resin solution: blending amount of polyurethane resin 30 mass %, blending amount of cyclohexanone 70 mass %) (polyurethane resin: number average molecular weight Mn=25000, glass transition temperature Tg=110° C.)
n-Butyl stearate: 2.00 parts by mass
Methyl ethyl ketone: 108.20 parts by mass
Toluene: 108.20 parts by mass
Cyclohexanone: 18.50 parts by mass

Finally, polyisocyanate (product name: Coronate L, manufactured by TOSOH CORPORATION): 2.49 parts by mass and stearic acid: 2.00 parts by mass were added as curing agents to the coating material for forming a base layer prepared as described above.

### (Step of Preparing Coating Material for Forming Back Layer)

A coating material for forming a back layer was prepared as follows. The following raw materials were mixed in a stirring tank equipped with a disper, and filter treatment was performed to prepare a coating material for forming a back layer.
Carbon black (product name: #80 manufactured by Asahi Corporation): 100.00 parts by mass
Polyester polyurethane: 100.00 parts by mass (product name: N-2304 manufactured by Nippon Polyurethane Industry Co., Ltd.)
Methyl ethyl ketone: 500.00 parts by mass
Toluene: 400.00 parts by mass
Cyclohexanone: 100.00 parts by mass
Polyisocyanate (product name: Coronate L, manufactured by TOSOH CORPORATION): 10.00 parts by mass

### (Coating Step)

Using the coating material for forming a magnetic layer and the coating material for forming a base layer prepared as described above, a base layer and a magnetic layer were formed on one main surface of an elongated PEN film (substrate) having an average thickness of 3.67 μm as follows. First, the coating material for forming a base layer was applied onto one main surface of the PEN film and dried to form a base layer so that the average thickness after the calendering treatment was 1.19 pam. Next, the coating material for forming a magnetic layer was applied onto the base layer and dried to form a magnetic layer so that the average thickness after the calendering treatment was 78 nm.

After forming the base layer and the magnetic layer, the coating material for forming a back layer was applied onto the other main surface of the PEN film and dried to form a back layer so that the average thickness after the calendering treatment was 0.50 μm. Therefore, a magnetic tape was obtained.

### (Curing Step)

After the magnetic tape was wound into a roll shape, the magnetic tape was heated at 60° C. for 50 hours in this state to cure the base layer and magnetic layer.

### (Calendar Step)

The cured magnetic tape was calendered to smooth the surface of the magnetic layer. At this time, the calendering temperature was set to 100° C., and the calendering pressure was set to 200 kg/cm.

### (Cutting Step)

The magnetic tape obtained as described above was cut into a width of ½ inches (12.65 mm). Therefore, a magnetic tape having an average thickness of 5.44 μm was obtained.

### (Servo Writing Step)

After the cut magnetic tape was demagnetized, a servo pattern was written on the magnetic tape using a servo writer to form five servo bands. The servo pattern conforms to the LTO-9 standard. As a result, a target magnetic tape was obtained.

### Examples 2 and 3 and Comparative Examples 1 and 3

### <Step of Preparing Magnetic Powder>

A barium ferrite magnetic powder was obtained in a similar manner to the step of preparing a magnetic powder of Example 1, except that in the raw material mixing step, sodium tetraborate (Na₂B₄O₇), barium carbonate (BaCO₃), iron oxide (Fe₂O₃), titanium oxide (TiO₂), neodymium oxide (Nd₂O₃), and aluminum oxide (Al₂O₃) were weighed so as to have the mixing ratio shown in Table 1, and these were mixed with a powder mixer.

### <Step of Preparing Magnetic Tape>

In the step of preparing a coating material for forming a magnetic layer, the barium ferrite magnetic powder obtained as described above was used. Furthermore, in the coating step, the coating conditions of each coating material were adjusted so that a film having an average thickness shown in Table 2 was used as a PEN film (substrate), and the average thickness of the magnetic layer, the average thickness of the base layer, and the average thickness of the back layer after the calendering treatment were the values shown in Table 2. A magnetic tape was obtained in a similar manner to the step of preparing the magnetic tape of Example 1 except for the above.

### Comparative Example 2

### <Step of Preparing Magnetic Powder>

A barium ferrite magnetic powder was obtained in a similar manner to the step of preparing a magnetic powder of Example 1, except that in the raw material mixing step, sodium tetraborate (Na₂B₄O₇), barium carbonate (BaCO₃), iron oxide (Fe₂O₃), titanium oxide (TiO₂), and aluminum oxide (Al₂O₃) were weighed so as to have the mixing ratio shown in Table 1, and these were mixed with a powder mixer.

### <Step of Preparing Magnetic Tape>

In the step of preparing a coating material for forming a magnetic layer, the barium ferrite magnetic powder obtained as described above was used. Furthermore, in the coating step, the coating conditions of each coating material were adjusted so that a film having an average thickness shown in Table 2 was used as a PEN film (substrate), and the average thickness of the magnetic layer, the average thickness of the base layer, and the average thickness of the back layer after the calendering treatment were the values shown in Table 2. A magnetic tape was obtained in a similar manner to the step of preparing the magnetic tape of Example 1 except for the above.

### Comparative Example 4

### <Step of Preparing Magnetic Powder>

A strontium ferrite magnetic powder (barium-containing strontium ferrite magnetic powder) was obtained in a similar manner to the step of preparing a magnetic powder of Example 1, except that in the raw material mixing step, boric acid (B₂O₃), barium carbonate (BaCO₃), strontium carbonate (SrCO₃), iron oxide (Fe₂O₃), titanium oxide (TiO₂), and neodymium oxide (Nd₂O₃) were weighed so as to have the mixing ratio shown in Table 1, and these were mixed with a powder mixer.

### <Step of Preparing Magnetic Tape>

In the step of preparing a coating material for forming a magnetic layer, the strontium ferrite magnetic powder obtained as described above was used. Furthermore, in the coating step, the coating conditions of each coating material were adjusted so that a film having an average thickness shown in Table 2 was used as a PEN film (substrate), and the average thickness of the magnetic layer, the average thickness of the base layer, and the average thickness of the back layer after the calendering treatment were the values shown in Table 2. A magnetic tape was obtained in a similar manner to the step of preparing the magnetic tape of Example 1 except for the above.

### Comparative Example 5

### <Step of Preparing Magnetic Powder>

A strontium ferrite magnetic powder was obtained in a similar manner to the step of preparing a magnetic powder of Example 1, except that in the raw material mixing step, sodium tetraborate (Na₂B₄O₇), strontium carbonate (SrCO₃), iron oxide (Fe₂O₃), titanium oxide (TiO₂), and aluminum oxide (Al₂O₃) were weighed so as to have the mixing ratio shown in Table 1, and these were mixed with a powder mixer.

### <Step of Preparing Magnetic Tape>

In the step of preparing a coating material for forming a magnetic layer, the barium ferrite magnetic powder obtained as described above was used. Furthermore, in the coating step, the coating conditions of each coating material were adjusted so that a film having an average thickness shown in Table 2 was used as a PEN film (substrate), and the average thickness of the magnetic layer, the average thickness of the base layer, and the average thickness of the back layer after the calendering treatment were the values shown in Table 2. A magnetic tape was obtained in a similar manner to the step of preparing the magnetic tape of Example 1 except for the above.

### [Evaluation]

The magnetic tape obtained as described above was evaluated as follows.

### [Arithmetic Average Roughness Ra]

The arithmetic average roughness Ra of the magnetic surface was determined as follows. First, the magnetic surface was observed with an AFM to obtain an AFM image of 40 μm×40 μm. As the AFM, Dimension ICON manufactured by Digital Instruments, Inc. and its analysis software were used, as a cantilever, a silicon single crystal cantilever was used (Note 1), and the measurement was performed by tuning at 200 to 400 Hz as a tapping frequency. Next, the AFM image is divided into 256×256 (=65,536) measurement points, the height Z(i) (i: measurement point number, i=1 to 65,536) is measured at each measurement point, and the measured heights Z(i) at the measurement points are simply averaged (arithmetically averaged) to determine an average height (average plane) Zave (═(Z(1)+Z(2)+ . . . +Z(65,536))/65,536). Subsequently, a deviation Z″(i) (=|Z(i)−Zave|) from the average center line at each measurement point was determined, and the arithmetic average roughness Ra [nm](=(Z″(1)+Z″(2)+ . . . +Z″(65,536))/65,536) was calculated. At this time, as the image processing, data obtained by performing filtering processing by Flatten order 2 and planefit order 3 XY was used.

(Note 1) SPM probe NCH normal type PointProbe L (cantilever length)=125 μm, manufactured by NanoWorld Corporation

### [PSD]

The PSD up to a spatial wavelength of 5 μm on the magnetic surface was determined by the method described in the above-described embodiment.

### [Coercive Force Hc]

The coercive force of the magnetic layer in the perpendicular direction of the magnetic tape was determined by the method described in the above-described embodiment.

### [Residual Coercive Force Hr and Saturation Magnetic Field Hs]

The residual coercive force Hr and the saturation magnetic field Hs of the magnetic layer measured by applying a pulse magnetic field in the perpendicular direction of the magnetic tape MT were determined by the method described in the above-described embodiment.

### [Ratio Hc/Hr]

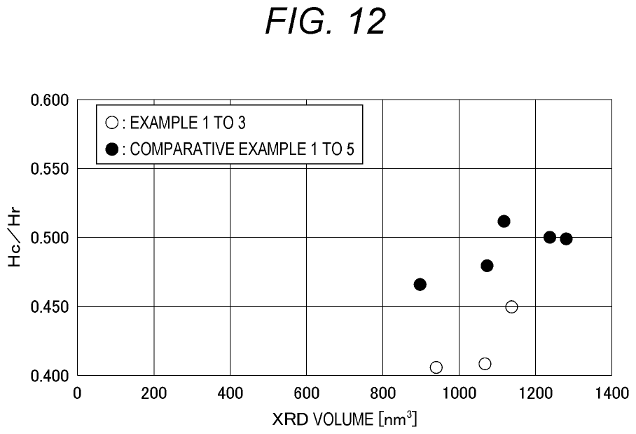

The ratio Hc/Hr was determined using the coercive force Hc and the residual coercive force Hr measured as described above. FIG. 12 shows a relationship between the particle volume of the magnetic powder and the ratio Hc/Hr.

### [SNR]

First, a reproduction signal of the magnetic tape was acquired using a loop tester (manufactured by MicroPhysics, Inc.). An acquisition condition of the reproduction signal will be described below.
Head: LTO9 specification Write Read Head
Headspeed: 1.85 m/s
Signal: single recording frequency 10 MHz (as a 2T half Nyquist frequency)
Recording current: optimum recording current

Next, the reproduction signal was captured at a span of 0 to 20 MHz (resolution band width=100 kHz, VBW=30 kHz) by a spectrum analyzer. Next, a peak of the captured spectrum was defined as a signal amount S, floor noise excluding the peak was integrated from 3 MHz to 20 MHz to define a noise amount N, and a ratio S/N of the signal amount N and the noise amount N was determined as a signal-to-noise ratio (SNR). Next, the determined SNR was converted into a relative value (dB) based on the SNR of Comparative Example 5 as a reference medium.

TABLE 1

| | Magnetic | | | | | | | | |
|---|---|---|---|---|---|---|---|---|---|
| | powder | Na₂B₄O₇ | B₂O₃ | BₐCO₃ | SrCO₃ | Fe₂O₃ | TiO₂ | Nd₂O₃ | Al₂O₃ |
| | type | [mol %] | [mol %] | [mol %] | [mol %] | [mol %] | [mol %] | [mol %] | [mol %] |
| Example 1 | BaFe | 30 | 0 | 30 | 0 | 32 | 3 | 0 | 5 |
| Example 2 | BaFe | 30 | 0 | 30 | 0 | 35 | 2 | 1 | 2 |
| Example 3 | BaFe | 30 | 0 | 30 | 0 | 32 | 2 | 1 | 5 |
| Comparative | BaFe | 30 | 0 | 30 | 0 | 35 | 2 | 1 | 2 |
| Example 1 | | | | | | | | | |
| Comparative | BaFe | 30 | 0 | 30 | 0 | 32 | 3 | 0 | 5 |
| Example 2 | | | | | | | | | |
| Comparative | BaFe | 30 | 0 | 28 | 0 | 34 | 2 | 5 | 1 |
| Example 3 | | | | | | | | | |
| Comparative | SrFe | 0 | 27 | 9 | 37 | 24 | 1 | 2 | 0 |
| Example 4 | | | | | | | | | |
| Comparative | SrFe | 25 | 0 | 0 | 46 | 28 | 1 | 0 | 0 |
| Example 5 | | | | | | | | | |

TABLE 2

| | Magnetic | Magnetic | Base | Back | Substrate | Arithmetic | |
|---|---|---|---|---|---|---|---|
| | tape | layer | layer | layer | (PEN) | average | PSD |
| | average | average | average | average | average | roughness | (≤5 |
| | thickness | thickness | thickness | thickness | thickness | Ra | μm) |
| | [μm] | [nm] | [μm] | [μm] | [μm] | [nm] | [nm²] |
| Example 1 | 5.44 | 78 | 1.19 | 0.50 | 3.67 | 1.24 | 1.32 |
| Example 2 | 5.31 | 75 | 1.20 | 0.46 | 3.57 | 1.20 | 1.11 |
| Example 3 | 5.22 | 71 | 1.21 | 0.43 | 3.51 | 1.18 | 1.33 |
| Comparative | 5.14 | 69 | 1.14 | 0.41 | 3.52 | 1.24 | 1.40 |
| Example 1 | | | | | | | |
| Comparative | 5.33 | 74 | 1.20 | 0.46 | 3.60 | 1.28 | 1.35 |
| Example 2 | | | | | | | |
| Comparative | 5.33 | 73 | 1.20 | 0.48 | 3.58 | 1.22 | 1.45 |
| Example 3 | | | | | | | |
| Comparative | 5.25 | 82 | 1.20 | 0.43 | 3.54 | 1.27 | 1.56 |
| Example 4 | | | | | | | |
| Comparative | 5.81 | 90 | 1.34 | 0.42 | 3.96 | 1.29 | 1.57 |
| Example 5 | | | | | | | |

TABLE 3

| | | Magnetic characteristics | | | | Electromagnetic |
|---|---|---|---|---|---|---|
| | | of magnetic tape | | | | conversion |
| | | | Residual | Saturation | | characteristics |
| | | | coercive | magnetic | | SNR |
| | Magnetic | | force | field | | (relative |
| | powder | | (pulse | (pulse | | value |
| | Particle | Coercive | magnetic | magnetic | | based on |
| | volume | force | field) | field) | | Comparative |
| | V_{XRD} | Hc | Hr | Hs | | Example 5) |
| | [nm³] | [Oe] | [Oe] | [Oe] | Hc/Hr | [dB] |
| Example 1 | 942 | 1770 | 4366 | 9000 | 0.41 | 0.90 |
| Example 2 | 1139 | 2134 | 4752 | 7500 | 0.45 | 0.91 |
| Example 3 | 1068 | 1806 | 4426 | 7600 | 0.41 | 0.91 |
| Comparative | 1238 | 2453 | 2901 | 8000 | 0.50 | 0.83 |
| Example 1 | | | | | | |
| Comparative | 1280 | 2352 | 4663 | 7800 | 0.50 | 0.79 |
| Example 2 | | | | | | |
| Comparative | 1073 | 2139 | 4460 | 7800 | 0.48 | 0.78 |
| Example 3 | | | | | | |
| Comparative | 1115 | 2496 | 4877 | 8500 | 0.51 | 0.52 |
| Example 4 | | | | | | |
| Comparative | 896 | 2438 | 5234 | 9100 | 0.47 | 0.00 |
| Example 5 | | | | | | |

The following is found from the evaluation results described above.

The SNR of the magnetic tape having a ratio Hc/Hr of 0.45 or less (Examples 1 to 3) is higher than the SNR of the magnetic tape having a ratio Hc/Hr of more than 0.45 (Comparative Examples 1 to 5). Thus, even in a case where the particle volume of the magnetic powder contained in the magnetic layer is 1300 nm³ or less, the SNR of the magnetic tape can be improved by setting the ratio Hc/Hr to 0.45 or less.

The embodiments and modifications thereof of the present disclosure have been specifically described above, but the present disclosure is not limited to the above-described embodiments and modifications thereof, and various modifications based on the technical idea of the present disclosure may be made. For example, configurations, methods, processes, shapes, materials, numerical values, and the like in the above-described embodiments and modifications are merely examples, and different configurations, methods, processes, shapes, materials, numerical values, and the like may be employed as necessary. The configurations, methods, processes, shapes, materials, numerical values, and the like of the above-described embodiments and modifications can be combined with each other without departing from the gist of the present disclosure.

The chemical formulas of compounds and the like exemplified in the above-described embodiments and modifications are representative, and are not limited to the valences and the like described herein as long as the compounds with the same general names are employed. In numerical value ranges described in stages in the embodiment and modifications described above, an upper limit value or a lower limit value of a numerical value range of a certain stage may be replaced with the upper limit value or the lower limit value of the numerical value range of another stage. The materials exemplified in the embodiments and modifications described above may be used alone or in combination of two or more unless otherwise specified.

Furthermore, the present disclosure can adopt the following configurations.

(1)

A magnetic recording medium having a tape shape, the magnetic recording medium including:
a substrate; and
a magnetic layer containing a magnetic powder,
in which a particle volume of the magnetic powder as determined by X-ray diffraction is 1300 nm³ or less, and
a ratio Hc/Hr of a coercive force Hc of the magnetic layer in a perpendicular direction of the magnetic recording medium and a residual coercive force Hr of the magnetic layer measured by applying a pulse magnetic field in the perpendicular direction of the magnetic recording medium is 0.45 or less.
   (2)

The magnetic recording medium according to (1),
in which the coercive force Hc of the magnetic layer in the perpendicular direction of the magnetic recording medium is 3000 Oe or less.
   (3)

The magnetic recording medium according to (1) or (2),
in which the residual coercive force Hr of the magnetic layer measured by applying a pulse magnetic field in the perpendicular direction of the magnetic recording medium is 5000 Oe or less.
   (4)

The magnetic recording medium according to any one of (1) to (3),
in which a saturation magnetic field Hs of the magnetic layer measured by applying a pulse magnetic field in the perpendicular direction of the magnetic recording medium is 9200 Oe or less.
   (5)

The magnetic recording medium according to any one of (1) to (4),
in which a power spectrum density (PSD) of the magnetic layer up to a spatial wavelength of 5 μm is 1.33 nm² or less.
   (6)

The magnetic recording medium according to any one of (1) to (5),
in which the magnetic powder contains hexagonal ferrite particles.
   (7)

The magnetic recording medium according to any one of (1) to (6),
in which an average thickness of the magnetic layer is 60 nm or less.
   (8)

The magnetic recording medium according to any one of (1) to (7), further including
a base layer,
in which an average thickness of the base layer is 0.90 μm or less.
   (9)

The magnetic recording medium according to claim 1,
in which an average thickness of the magnetic recording medium is 5.50 μm or less.
   (10)

The magnetic recording medium according to any one of (1) to (9),
in which the magnetic layer has a servo pattern,
the servo pattern includes a plurality of first magnetized regions and a plurality of second magnetized regions, and
the plurality of first magnetized regions and the plurality of second magnetized regions are asymmetric with respect to an axis parallel to a width direction of the magnetic recording medium.
   (11)

The magnetic recording medium according to (10),
in which an inclination angle of the first magnetized region with respect to the axis is different from an inclination angle of the second magnetized region with respect to the axis, and
a larger inclination angle of the inclination angle of the first magnetized region and the inclination angle of the second magnetized region is 18° or more and 28° or less.
   (12)

A cartridge including the magnetic recording medium according to any one of (1) to (11).

### REFERENCE SIGNS LIST

10, 321 Cartridge
11 Cartridge memory
31 Antenna coil
32 Rectification and power circuit
33 Clock circuit
34 Detection and modulation circuit
35 Controller
36 Memory
36A First storage region
36B Second storage region
41 Substrate
42 Base layer
43 Magnetic layer
44 Back layer
56 Head unit
56A, 56B Servo read head
110 Servo frame
111 Servo sub-frame 1
112 Servo sub-frame 2
113 Servo stripe
111A A burst
111B B burst
112C C burst
112D D burst
MT Magnetic tape
SB Servo band
DB Data band
Tk Data track

1. A magnetic recording medium having a tape shape, the magnetic recording medium comprising:
a substrate; and
a magnetic layer containing a magnetic powder,
wherein
a particle volume of the magnetic powder as determined by X-ray diffraction is 1300 nm³ or less, and
a ratio Hc/Hr of a coercive force Hc of the magnetic layer in a perpendicular direction of the magnetic recording medium and a residual coercive force Hr of the magnetic layer measured by applying a pulse magnetic field in the perpendicular direction of the magnetic recording medium is 0.45 or less.

2. The magnetic recording medium according to claim 1,
wherein the coercive force Hc of the magnetic layer in the perpendicular direction of the magnetic recording medium is 3000 Oe or less.

3. The magnetic recording medium according to claim 1,
wherein the residual coercive force Hr of the magnetic layer measured by applying a pulse magnetic field in the perpendicular direction of the magnetic recording medium is 5000 Oe or less.

4. The magnetic recording medium according to claim 1,
wherein a saturation magnetic field Hs of the magnetic layer measured by applying a pulse magnetic field in the perpendicular direction of the magnetic recording medium is 9200 Oe or less.

5. The magnetic recording medium according to claim 1,
wherein a power spectrum density (PSD) of the magnetic layer up to a spatial wavelength of 5 μm is 1.33 nm² or less.

6. The magnetic recording medium according to claim 1,
wherein the magnetic powder contains hexagonal ferrite particles.

7. The magnetic recording medium according to claim 1,
wherein an average thickness of the magnetic layer is 60 nm or less.

8. The magnetic recording medium according to claim 1, further comprising
a base layer,
wherein an average thickness of the base layer is 0.90 μm or less.

9. The magnetic recording medium according to claim 1,
wherein an average thickness of the magnetic recording medium is 5.50 μm or less.

10. The magnetic recording medium according to claim 1,
wherein the magnetic layer has a servo pattern,
the servo pattern includes a plurality of first magnetized regions and a plurality of second magnetized regions, and
the plurality of first magnetized regions and the plurality of second magnetized regions are asymmetric with respect to an axis parallel to a width direction of the magnetic recording medium.

11. The magnetic recording medium according to claim 10,
wherein an inclination angle of the first magnetized region with respect to the axis is different from an inclination angle of the second magnetized region with respect to the axis, and
a larger inclination angle of the inclination angle of the first magnetized region and the inclination angle of the second magnetized region is 18° or more and 28° or less.

12. A cartridge comprising the magnetic recording medium according to claim 1.
